(19) United States
(12) Patent Application Publication
(10) Pub. No.: US 2018/0197187 A1
(43) Pub. Date: Jul. 12, 2018

(54) INSPECTION DEVICE AND INSPECTION METHOD

(71) Applicant: HOI YING CHUNG, HONG KONG (CN)

(72) Inventors: HOI YING CHUNG, HONG KONG (CN); WING KIN HUI, HONG KONG (CN); FONG MAN HUI, HONG KONG (CN)

(21) Appl. No.: 15/721,490

(22) Filed: Sep. 29, 2017

(30) Foreign Application Priority Data
Jan. 6, 2017 (CN) 201710011082.3

(51) Int. Cl. G06Q 30/00; G06K 7/10

(52) U.S. Cl. CPC G06Q 30/0185; G06K 7/10366; G06K 7/10297

(57) ABSTRACT

The present invention is adapted to the technical field of commodity anti-counterfeiting, and provides an inspection device and an inspection method, comprising: an input device communicatively connected to a verification report server and a verification server, respectively; the input device for activating security data of a quality inspector of the commodity, transmitting the security data to the verification report server for verification, reading an anti-counterfeiting code of the commodity after the security data pass verification, and transmitting the anti-counterfeiting code to the verification server; the verification report server for receiving the security data and verifying the security data; and the verification server for receiving the anti-counterfeiting code of the commodity to verify the anti-counterfeiting code. Thus, the present invention realizes authentication of personnel who is responsible for inspecting the commodity, and ensures qualified professional to inspect the commodity.

### FIELD OF THE INVENTION

The present invention relates to the commodity anti-counterfeiting technical field, especially relates to an inspection device and an inspection method.

### DISCUSSION OF THE PRIOR ART

Nowadays, with people's life becomes increasingly rich, more and more commodities are purchased by the consumers. However, some high quality commodities are often counterfeited by law breakers, and this brings huge discontent to the producers, retailers and consumers. Particularly, the consumers do not hope to purchase counterfeit commodity while also hope that more information of the commodity can be acquired after purchasing it.

Thus, in the prior art, for example, the invention with an application No. CN201510423419.2, entitled “Electronic Anti-counterfeiting System and Electronic Anti-counterfeiting Method”, provides an electronic anti-counterfeiting technology. To be specific, the patent application provides an electronic anti-counterfeiting system configured to comprise: a server disposed in a data center, a database of the server storing information of a logistics code and an anti-counterfeiting code of the commodity, and information of production, transportation, sales and authenticity of the commodity corresponding to the information of the logistics code and the anti-counterfeiting code; a point-of-sale terminal transmitting sales information of the commodity to the server and/or transmitting the anti-counterfeiting code of the commodity to an inquiry terminal after reading the logistics code of the commodity; the inquiry terminal transmitting the anti-counterfeiting code to the server after reading the anti-counterfeiting code of the commodity, and acquiring information of an inquiry result returned from the server. Package of the commodity is provided with a single logistics code of the commodity; the commodity and/or inner package of the commodity is provided with a single anti-counterfeiting code of the commodity, so authenticity and the associated information of the commodity may be inquired through the anti-counterfeiting of the commodity, which improves reliability of inquiring authenticity of the commodity through the anti-counterfeiting code. In addition, the whole circulation process of the commodity from production to the consumers also may be recorded through the logistics code. Thus, it also adds providing more information to the consumers while ensuring authenticity of the inquired commodity, and particularly, the same commodity can provide corresponding information for the consumers' reference when making several inquiries, and solves the counterfeiting problem due to relaxed confidentiality and leakage of the electronic anti-counterfeiting code in the prior art.

However, the patent application does not have record recording inspection of the commodity. The technical solution of the patent application is to inspect after the consumers purchase the consumption commodity, and handle the commodity by the consumers themselves without necessity of cheating, and is the technical solution without inspection protection of intermediate suppliers. Thus, with respect to the action of receiving/inspecting by employees or outsourcing supervisors in commerce/industry, the employers or management determining the receiving/inspection record may have the circumstances of insecurity and modification.

As can be known, the current technology of inspecting the commodity obviously has inconvenience and defects in practical use, so it is necessary to make improvement.

### SUMMARY OF THE INVENTION

With respect to the above defects, the purpose of the present invention is to provide an inspection device and an inspection method so as to realize authentication of personnel who is responsible for inspecting the commodity, and ensures qualified professional to inspect the commodity.

In order to realize the above purpose, the present invention provides an inspection device, comprising:

an input device communicatively connected to a verification report server and a verification server, respectively; the input device for activating security data of a quality inspector of the commodity, transmitting the security data to the verification report server for verification, reading an anti-counterfeiting code of the commodity after the security data pass verification, and transmitting the anti-counterfeiting code to the verification server;

the verification report server for receiving the security data and verifying the security data; and

the verification server for receiving the anti-counterfeiting code of the commodity to verify the anti-counterfeiting code.

According to the inspection device, the security data include an unencrypted portion and an encrypted portion;

the unencrypted portion includes number of the quality inspector;

the encrypted portion includes the number of the quality inspector, global positioning coordinates of the input device, logon time of the input device and number of the input device, which are encrypted with a private key;

after the input device activates the security data and transmits the security data to the verification report server, the verification report server decrypts the encrypted portion with a public key corresponding to the private key, and acquires the security data;

the input device further includes an encryption lock where the security data are stored; the encryption lock having a preset encrypted activation code and a preset decryption program;

the input device includes:

a pre-installed module for pre-installing the encrypted activation code;

a first transmission module for transmitting the encrypted activation code pre-installed in the pre-installed module to the encryption lock when the input device activates the security data of the quality inspector of the commodity;

a first receiving module for transmitting the confidential data in an encryption way after the encryption lock receives and confirms the activation code of the encryption lock to be correct; and

a first decryption module for decrypting the security data with the preset decryption program and transmitting the security data to the verification report server;

the inspection device further comprises:

at least one security encoder generating a token having a time limit for the quality inspector, the token being invalid when reaching the time limit; and

the input device further includes:

a first storage module for storing information of the token;

a first input module for inputting the token when the input device activates the security data of the quality inspector of the commodity;

a first judgment module for checking the token input from the first input module according to the information of the token stored in the first storage module;

an activation module for activating the security data of the quality inspector after the first judgment module judges the token to be correct; and

a first transmission module for transmitting the activated security data of the quality inspector to the verification report server.

According to the inspection device, the security encoder has a preset security encoder activation password, and the security encoder is activated with the security encoder password;

after the first judgment module checks the token input from the first input module to be correct, the activation module activates the security data of the quality inspector stored in the first storage module.

According to the inspection device, the first storage module stores a biological feature information base including biological feature information of the quality inspector, and the input device further includes:

a biological feature reading device for reading biological features of the quality inspector, and judging whether the biological features of the quality inspector are consistent with the biological features in the biological feature information base stored within the first storage module; and

the activation module activates the security data when the biological feature reading device judges and reads the biological features of the quality inspector to be consistent with the biological features in the biological feature information base stored within the first storage module.

According to the inspection device, the biological feature reading device includes a scanning fingerprint instrument and/or a scanning eyeball iris instrument.

According to the inspection device, the encryption lock is disposed on a shell of the input device, and the encryption lock is connected to the input device via a USB interface.

According to the inspection device, the verification report server includes:

a second receiving module for receiving the activated security data of the quality inspector transmitted by the input device;

a second decryption module for decrypting the encrypted portion with a public key corresponding to the private key, and acquiring the security data;

a recording module for recording last logon time and address of the quality inspector; and

a second judgment module for judging whether movement of the quality inspector is reasonable according to the global positioning coordinates of the input device, if reasonable, allowing the quality inspector to login, and if unreasonable, not allowing the quality inspector to login.

According to the inspection device, the anti-counterfeiting code of the commodity is printed on the commodity, or sticks on the commodity in a form of sticker; the anti-counterfeiting code includes optical readable characters, bar code and QR code;

the input device further includes:

a scanning lens or camera lens for scanning or reading the anti-counterfeiting code;

a conversion module for converting the scanned anti-counterfeiting code into a digital anti-counterfeiting code; and

the first transmission module transmits the converted anti-counterfeiting code to the verification server.

According to the inspection device, the anti-counterfeiting code is stored in a read only low frequency RFIDtag or stored in a rewritable high frequency RFIDtag;

the input device further includes:

a near field communication device for reading the anti-counterfeiting code stored in the low frequency RFIDtag, or reading the anti-counterfeiting code stored in the high frequency RFIDtag and verification status of the high frequency RFIDtag;

a conversion module for converting the scanned anti-counterfeiting code into a digital anti-counterfeiting code; and

the first transmission module transmits the converted anti-counterfeiting code to the verification server.

According to the inspection device, the anti-counterfeiting code is stored in a rewritable iBeacon device; the iBeacon sticks on the commodity to be damageable when removing, or is removably installed on the commodity in a separate tag or other ways; an iBeacon power supply storing the anti-counterfeiting code is charged with electricity to activate the iBeacon after damageable removing the barrier;

the input device further includes:

a Bluetooth read-write device for reading the anti-counterfeiting code stored in the iBeacon and updating the verification status of the iBeacon device;

a conversion module for converting the scanned anti-counterfeiting code into a digital anti-counterfeiting code; and

the first transmission module transmits the converted anti-counterfeiting code to the verification server.

According to the inspection device, the verification server includes a first anti-counterfeiting database;

the verification server searches in the first anti-counterfeiting database after receiving the anti-counterfeiting code, verifies whether the commodity represented by the anti-counterfeiting code is real, and returns a verification result to the input device;

the input device receives the verification result of the verification server, displays on a display of the input device, and records verification record data whether the commodity is real in the input device;

the verification record data include number of the quality inspector, verification time whether the commodity is real, satellite positioning coordinates and sea level of the input device at the verification time, and the verification result whether the commodity is real; and

the verification result whether the commodity is real includes:

the commodity associated with the anti-counterfeiting code is not real—no such commodity;

the commodity associated with the anti-counterfeiting code has been sold, but not inspected, and the commodity is real;

the commodity associated with the anti-counterfeiting code is not sold, and the commodity is not real—not sold;

the commodity associated with the anti-counterfeiting code has been sold and has been inspected, and the commodity is real—but inspect repeatedly.

According to the inspection device, the first input module of the input device includes a keyboard and a display device, the quality inspector inputs the anti-counterfeiting code by the keyboard, and the keyboard includes a physical keyboard or a touch type keyboard which is formed of a part of positions of the display device.

According to the inspection device, the input device is wired or wireless communicatively connected to the verification server and the verification report server, respectively; and

the wireless communicatively connection includes WIFI network connection, Bluetooth connection or mobile network connection.

According to the inspection device, the verification server includes a second anti-counterfeiting database; the verification report server and the verification server are also used for updating verification information of the anti-counterfeiting code of the commodity synchronously in the second anti-counterfeiting database of the verification report server and the first anti-counterfeiting database of the verification report server, respectively, after the anti-counterfeiting code of the commodity passes verification;

the verification report server includes:

a second receiving module for receiving an anti-counterfeiting code preparation inspection requirement of the commodity;

a second judgment module for judging whether the anti-counterfeiting code preparation inspection requirement of the commodity exists in the first anti-counterfeiting database, if existing, not adding the anti-counterfeiting code preparation inspection requirement in the first anti-counterfeiting database, and if not existing, adding the anti-counterfeiting code preparation inspection requirement in the first anti-counterfeiting database; and

the verification server further includes:

a third receiving module for receiving the anti-counterfeiting code preparation inspection requirement of the commodity;

a third judgment module for judging whether the anti-counterfeiting code preparation inspection requirement of the commodity exists in the second anti-counterfeiting database, if existing, not adding the anti-counterfeiting code preparation inspection requirement in the second anti-counterfeiting database, and if not existing, adding the anti-counterfeiting code preparation inspection requirement in the second anti-counterfeiting database.

According to the inspection device, the verification server further includes:

a first searching module for searching corresponding anti-counterfeiting code record with the anti-counterfeiting code of the commodity in the first anti-counterfeiting database of the verification server, downloading the anti-counterfeiting code record searched in the first anti-counterfeiting database to the first storage module of the input device, and storing as data record before update of the anti-counterfeiting code;

a first updating module for updating the anti-counterfeiting code of the commodity in the first anti-counterfeiting database of the verification server, and updating the record successfully when the searched anti-counterfeiting code record is consistent with the anti-counterfeiting data record after update stored in the input device.

According to the inspection device, the verification server further includes:

a second searching module for searching the anti-counterfeiting code record with the anti-counterfeiting code in the first anti-counterfeiting database; and

a first replying module for replying updating successful or unsuccessful result to the input device after comparing the searched result with the anti-counterfeiting data stored in the input device.

According to the inspection device, the first storage module of the input device stores anti-counterfeiting data log record;

the verification server further includes:

an establishing module for establishing an anti-counterfeiting data log database in the verification server;

a third searching module for searching with the anti-counterfeiting code and the number of the quality inspector in the anti-counterfeiting data log database, and when the search result is one or more records, finding out whether the one or more records is consistent with the anti-counterfeiting data log record; and

a first deleting module for deleting the one or more records when the one or more records is consistent with the anti-counterfeiting data log record.

According to the inspection device, the verification report server further includes:

a fourth searching module for searching record of the anti-counterfeiting code preparation inspection requirement with the anti-counterfeiting code in the first anti-counterfeiting database after the first anti-counterfeiting database fails to add the anti-counterfeiting code preparation inspection requirement; and

a second deleting module for deleting the record of the anti-counterfeiting code preparation inspection requirement in the first anti-counterfeiting database when the record of the anti-counterfeiting code preparation inspection requirement is searched by the fourth searching module, and the number of the quality inspector in the record is the same as the number of the quality inspector who operates the input device.

According to the inspection device, the verification server further includes:

a fourth searching module for searching record of the anti-counterfeiting code preparation inspection requirement with the anti-counterfeiting code in the second anti-counterfeiting database after the second anti-counterfeiting database fails to add the anti-counterfeiting code preparation inspection requirement; and

a second deleting module for deleting the record of the anti-counterfeiting code preparation inspection requirement in the second anti-counterfeiting database when the record of the anti-counterfeiting code preparation inspection requirement is searched by the fourth searching module, and the number of the quality inspector in the record is the same as the number of the quality inspector who operates the input device.

In order to realize another purpose of the present invention, the present invention also provides an inspection method utilizing the inspection device, and the method comprises:

A. the input device activates security data of a quality inspector of the commodity, transmits the security data to the verification report server for verification, reads an anti-counterfeiting code of the commodity after the security data pass verification, and transmits the anti-counterfeiting code to the verification server;

B. the verification report server receives the security data and verifies the security data; and

C. the verification server receives the anti-counterfeiting code of the commodity to verify the anti-counterfeiting code.

According to the method, the security data includes an unencrypted portion and an encrypted portion;

the unencrypted portion includes number of the quality inspector;

the encrypted portion includes the number of the quality inspector, global positioning coordinates of the input device, logon time of the input device and number of the input device, which are encrypted using a private key;

after the input device activates the security data and transmits the security data to the verification report server, the verification report server decrypts the encrypted portion with a public key corresponding to the private key, and acquires the security data;

the input device further includes an encryption lock where the security data are stored; the encryption lock having a preset encrypted activation code and a preset decryption program;

the step that the input device activates the security data of the quality inspector of commodity and transmits the security data to the verification report server for verification comprises:

pre-installing, by the input device, the encrypted activation code;

transmitting the pre-installed encrypted activation code to the encryption lock when the input device activates the security data of the quality inspector of the commodity;

transmitting the confidential data to the input device in an encryption way after the encryption lock receives and confirms the activation code of the encryption lock to be correct, decrypting, by the input device, the security data with the preset decryption program and transmitting the security data to the verification report server for verification;

the inspection device further comprises:

at least one security encoder generating a token having a time limit for the quality inspector, the token being invalid when reaching the time limit;

the step that the input device activates the security data of the quality inspector of commodity and transmits the security data to the verification report server for verification further comprises:

storing, by the input device, information of the token;

inputting the token when the input device activates the security data of the quality inspector of the commodity;

checking, by the input device, the input token according to the information of the token, activating, by the input device, the security data of the quality inspector after judging the token to be correct; and transmitting the activated security data of the quality inspector to the verification report server.

According to the method, the security encoder has a preset security encoder activation password, and the security encoder is activated with the security encoder password;

activating the stored security data of the quality inspector after the input device checks the input token to be correct.

According to the method, the input device stores a biological feature information base including biological feature information of the quality inspector; the input device further includes a biological feature reading device;

the step that the input device activates the security data of the quality inspector of the commodity and transmits the security data to the verification report server for verification further comprises:

reading, by the biological feature reading device, biological features of the quality inspector, and judging whether the biological features of the quality inspector are consistent with the biological features in the biological feature information base; and

activating, by the input device, the security data when the biological feature reading device judges and reads the biological features of the quality inspector to be consistent with the biological features in the biological feature information base.

According to the method, the biological feature reading device includes a scanning fingerprint instrument and/or a scanning eyeball iris instrument.

According to the method, the encryption lock is disposed on a shell of the input device, and the encryption lock is connected to the input device via a USB interface.

According to the method, the step B comprises:

receiving, by the verification report server, the activated security data of the quality inspector transmitted by the input device;

decrypting, by the verification report server, the encrypted portion with a public key corresponding to the private key, and acquiring the security data;

recording, by the verification report server, last logon time and address of the quality inspector; and

judging, by the verification report server, whether movement of the quality inspector is reasonable according to the global positioning coordinates of the input device, if reasonable, allowing the quality inspector to login, and if unreasonable, not allowing the quality inspector to login.

According to the method, the anti-counterfeiting code of the commodity is printed on the commodity, or sticks on the commodity in a form of sticker; the anti-counterfeiting code includes optical readable characters, bar code and QR code;

the input device further includes a scanning lens or camera lens; the step of reading the anti-counterfeiting code of the commodity after the security data pass verification, and transmitting the anti-counterfeiting code to the verification server comprises:

scanning or reading, by the scanning lens or camera lens of the input device, the anti-counterfeiting code of the commodity;

converting, by the input device, the scanned anti-counterfeiting code into a digital anti-counterfeiting code; and

transmitting, by the input device, the converted anti-counterfeiting code to the verification server.

According to the method, the anti-counterfeiting code is stored in a read only low frequency RFIDtag or stored in a rewritable high frequency RFIDtag;

the input device further includes a near field communication device; the step of reading the anti-counterfeiting code of the commodity after the security data pass verification, and transmitting the anti-counterfeiting code to the verification server comprises:

reading, by the near field communication device of the input device, the anti-counterfeiting code stored in the low frequency RFIDtag, or the anti-counterfeiting code stored in the high frequency RFIDtag and verification status of the high frequency RFIDtag on the commodity;

converting, by the input device, the scanned anti-counterfeiting code into a digital anti-counterfeiting code; and

transmitting, by the input device, the converted anti-counterfeiting code to the verification server.

According to the method, the anti-counterfeiting code is stored in a rewritable iBeacon device; the iBeacon sticks on the commodity to be damageable when removing, or is removably installed on the commodity in a separate tag or other ways; an iBeacon power supply storing the anti-counterfeiting code is charged with electricity to activate the iBeacon after damageable removing the barrier;

the input device further includes a Bluetooth read-write device; the step of reading the anti-counterfeiting code of the commodity after the security data pass verification, and transmitting the anti-counterfeiting code to the verification server comprises:

reading, by the Bluetooth read-write device of the input device, the anti-counterfeiting code stored in the iBeacon and updating verification status of the iBeacon device;

converting, by the input device, the scanned anti-counterfeiting code into a digital anti-counterfeiting code; and

transmitting, by the input device, the converted anti-counterfeiting code to the verification server.

According to the method, the verification server includes a first anti-counterfeiting database; the step C comprises:

searching in the first anti-counterfeiting database after the verification server receives the anti-counterfeiting code, verifying whether the commodity represented by the anti-counterfeiting code is real, and returning a verification result to the input device;

the method further comprises:

receiving, by the input device, the verification result of the verification server, displaying on a display of the input device, and recording verification record data whether the commodity is real in the input device;

the verification record data include number of the quality inspector, verification time whether the commodity is real, satellite positioning coordinates and sea level of the input device at the verification time, and the verification result whether the commodity is real; and

the verification result whether the commodity is real includes:

the commodity associated with the anti-counterfeiting code is not real—no such commodity;

the commodity associated with the anti-counterfeiting code has been sold, but not inspected, and the commodity is real;

the commodity associated with the anti-counterfeiting code is not sold, and the commodity is not real—not sold;

the commodity associated with the anti-counterfeiting code has been sold and has been inspected, and the commodity is real—but inspect repeatedly.

According to the method, the input device includes a keyboard and a display device, the quality inspector inputs the anti-counterfeiting code by the keyboard; and

the keyboard includes a physical keyboard or a touch type keyboard which is formed of a part of positions of the display device.

According to the method, the input device is communicatively connected to the verification report server and the verification server, respectively; the input device is wired or wireless communicatively connected to the verification server and the verification report server, respectively; and

the wireless communicatively connection includes WIFI network connection, Bluetooth connection or mobile network connection.

According to the method, the verification server includes a second anti-counterfeiting database; the method further comprises:

updating, by the verification report server and the verification server, verification information of the anti-counterfeiting code of the commodity synchronously in the second anti-counterfeiting database of the verification report server and the first anti-counterfeiting database of the verification report server, respectively, after the anti-counterfeiting code of the commodity passes verification;

receiving, by the verification report server, an anti-counterfeiting code preparation inspection requirement of the commodity; judging whether the anti-counterfeiting code preparation inspection requirement of the commodity exists in the first anti-counterfeiting database, if existing, not adding the anti-counterfeiting code preparation inspection requirement in the first anti-counterfeiting database, and if not existing, adding the anti-counterfeiting code preparation inspection requirement in the first anti-counterfeiting database; and

receiving, by the verification server, the anti-counterfeiting code preparation inspection requirement of the commodity; judging whether the anti-counterfeiting code preparation inspection requirement of the commodity exists in the second anti-counterfeiting database, if existing, not adding the anti-counterfeiting code preparation inspection requirement in the second anti-counterfeiting database, and if not existing, adding the anti-counterfeiting code preparation inspection requirement in the second anti-counterfeiting database.

According to the method, the method further comprises:

searching, by the verification server, corresponding anti-counterfeiting code record with the anti-counterfeiting code of the commodity in the first anti-counterfeiting database of the verification server, downloading the anti-counterfeiting code record searched in the first anti-counterfeiting database to the first storage module of the input device, and storing as data record before update of the anti-counterfeiting code;

updating, by the verification server, the anti-counterfeiting code of the commodity in the first anti-counterfeiting database of the verification server, and updating the record successfully when the searched anti-counterfeiting code record is consistent with the anti-counterfeiting data record after update stored in the input device.

According to the method, the method further comprises:

searching, by the verification server, corresponding anti-counterfeiting code record with the anti-counterfeiting code of the commodity in the first anti-counterfeiting database of the verification server, downloading the anti-counterfeiting code record searched in the first anti-counterfeiting database to the input device, and storing as data record before update of the anti-counterfeiting code;

updating, by the verification server, the anti-counterfeiting code of the commodity in the first anti-counterfeiting database of the verification server, and updating the record successfully when the searched anti-counterfeiting code record is consistent with the anti-counterfeiting data record after update stored in the input device.

According to the method, the method further comprises:

searching, by the verification server, the anti-counterfeiting code record with the anti-counterfeiting code in the first anti-counterfeiting database; and

replying, by the verification server, updating successful or unsuccessful result to the input device after comparing the searched result with the anti-counterfeiting data stored in the input device.

According to the method, the input device stores anti-counterfeiting data log record;

the method further comprises:

establishing, by the verification server, an anti-counterfeiting data log database in the verification server;

searching, by the verification server, with the anti-counterfeiting code and the number of the quality inspector in the anti-counterfeiting data log database, and when the search result is one or more records, finding out whether the one or more records is consistent with the anti-counterfeiting data log record; and

deleting, by the verification server, the one or more records when the one or more records is consistent with the anti-counterfeiting data log record.

According to the method, the method further comprises:

searching, by the verification report server, record of the anti-counterfeiting code preparation inspection requirement with the anti-counterfeiting code in the first anti-counterfeiting database after the first anti-counterfeiting database fails to add the anti-counterfeiting code preparation inspection requirement; and

deleting, by the verification report server, the record of the anti-counterfeiting code preparation inspection requirement in the first anti-counterfeiting database when the record of the anti-counterfeiting code preparation inspection requirement exists, and the number of the quality inspector in the record is the same as the number of the quality inspector who operates the input device.

According to the method, the method further comprises:

searching, by the verification server, record of the anti-counterfeiting code preparation inspection requirement with the anti-counterfeiting code in the second anti-counterfeiting database after the second anti-counterfeiting database fails to add the anti-counterfeiting code preparation inspection requirement; and

deleting, by the verification server, the record of the anti-counterfeiting code preparation inspection requirement in the second anti-counterfeiting database when the record of the anti-counterfeiting code preparation inspection requirement exists, and the number of the quality inspector in the record is the same as the number of the quality inspector who operates the input device.

The inspection device provided by the present invention comprises an input device communicatively connected to a verification report server and a verification server, respectively; the input device for activating security data of a quality inspector of the commodity, transmitting the security data to the verification report server for verification, reading an anti-counterfeiting code of the commodity after the security data pass verification, and transmitting the anti-counterfeiting code to the verification server; the verification report server receiving the security data and verifying the security data; and the verification server receiving the anti-counterfeiting code of the commodity to verify the anti-counterfeiting code. Thus, it realizes authentication of personnel who is responsible for inspecting the commodity, and prevents a qualified professional from notifying another unqualified personnel of the account and password to inspect the commodity. Since identification of identity of the quality inspector is enhanced on the input device, and then the employer or management collects the inspection report, it realizes enhancing authentication of identity of the quality inspector on the input device and verification of recording the inspection time and address and other data, and ensures legal quality inspectors to inspect the commodity.

### BRIEF DESCRIPTION OF THE DRAWINGS

FIG. 1 is a structure diagram of the inspection device provided by the example of the present invention.

FIG. 2 is a structure diagram of the inspection device provided by the example of the present invention.

FIG. 3 is a flow chart of the inspection method provided by the example of the present invention.

FIG. 4 is a structure diagram of the input device provided by the example of the present invention.

FIG. 5 is a structure diagram of the input device provided by the example of the present invention.

FIG. 6 is a structure diagram of the encryption lock provided by the example of the present invention.

FIG. 7 is a structure diagram of the encryption lock provided by the example of the present invention.

FIG. 8 is a structure diagram of the security encoder provided by the example of the present invention.

FIG. 9A is a structure diagram of the shell in the input device provided by the example of the present invention.

FIG. 9B is a structure diagram of the mobile phone in the input device provided by the example of the present invention.

FIG. 9C is an assembled structure diagram of the input device provided by the example of the present invention.

### DETAILED DESCRIPTION OF THE ILLUSTRATED EMBODIMENTS

In order make the purpose, technical solution and advantages of the present invention clearer, further explanations are made to the present invention with reference to the drawings and examples. It shall be understood that the detailed examples described here are only used to explain the present invention, but not to limit the present invention.

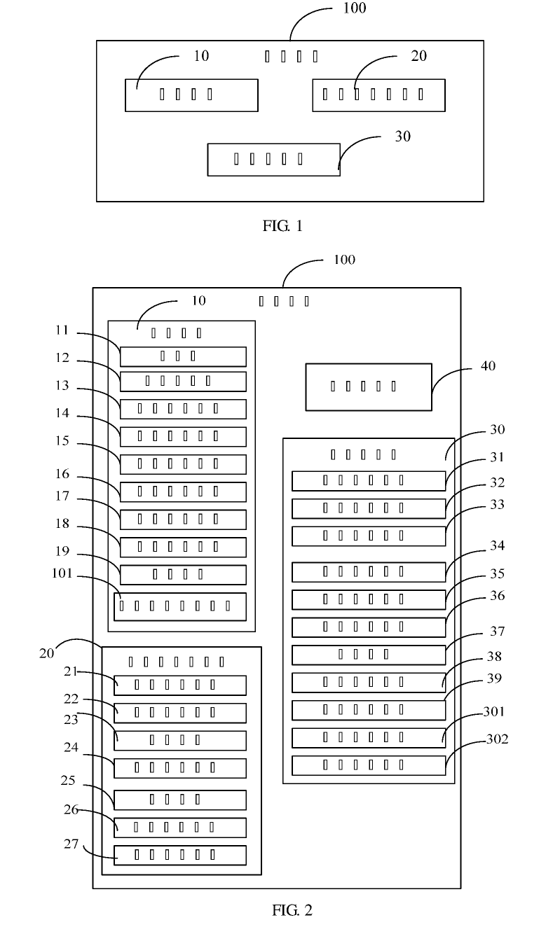

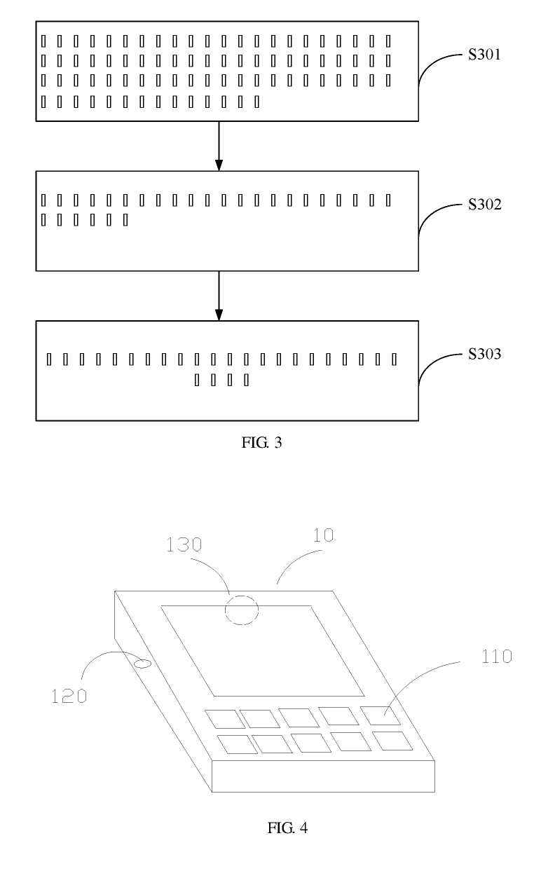

Referring to FIG. 1, in the first example of the present invention, it provides an inspection device 100, comprising:

an input device 10 communicatively connected to a verification report server 20 and a verification server 30; the input device 10 for activating security data of a quality inspector of the commodity, transmitting the security data to the verification report server 20 for verification, reading an anti-counterfeiting code of the commodity after the security data pass verification, and transmitting the anti-counterfeiting code to the verification server 30;

the verification report server 20 for receiving the security data and verifying the security data; and

the verification server 30 for receiving the anti-counterfeiting code of the commodity to verify the anti-counterfeiting code.

In this example, the inspection device 100 comprises the input device 10, the verification report server 20 and the verification server 30. The quality inspector of the commodity has security data for the function of identification of identity to ensure the quality inspector who has permission to inspect the commodity. Moreover, these security data are activated by the input device 10, and transmitted to the verification report server 20 which verifies these security data. After the security data pass verification, the input device 10 reads an anti-counterfeiting code of the commodity, and transmits the anti-counterfeiting code of the commodity to the verification server 30 to verify the anti-counterfeiting code.

In one embodiment of the present invention, the input device 10 is used for inputting the anti-counterfeiting code of the commodity, and preparing a verification report after verifying the material. The input device 10 may be an intelligent mobile device, which includes a mobile device with mobile phones as a main part and other devices, and a mobile device using an application running on the mobile device to input inspection data, or for specific use. In another embodiment, the input device 10 is a desktop device, including desktop computers as a main part and other devices to input the inspection data. When inspecting goods including large materials, such as prefabricated aluminum window, rebar, cement, bathroom components and the like at construction site, under such circumstance, the mobile input device 10 is more suitable. When inspecting goods including large pieces of cloth, small buttons, tacks, prefabricated collar, prefabricated sleeve and the like in the clothing factory, the mobile and desktop input devices 10 may both be used.

As for the security data, preferably, the security data include an unencrypted portion and an encrypted portion, wherein the unencrypted portion includes number of the quality inspector; the encrypted portion includes the number of the quality inspector, global positioning coordinates of the input device 10, logon time of the input device 10 and number of the input device 10, which are encrypted with a private key;

after the input device 10 activates the security data and transmits the security data to the verification report server 20, the verification report server 20 decrypts the encrypted portion with a public key corresponding to the private key, and acquires the security data.

In this example, the input device 10 further includes reading the number of the quality inspection personnel (quality inspector) and the private key in the public key infrastructure (PKI) safely. Further, when inspecting the above goods, the input device 10 also can read the security data including the private key and the like of the quality inspector when reading the anti-counterfeiting code of the goods.

In one embodiment of the present invention, the input device 10 is wired or wireless communicatively connected to the verification server 30 and the verification report server 20, respectively. The wireless communicatively connection includes WIFI network connection, Bluetooth connection or mobile network connection. The input device 10 includes communication means to be wired including local area network (LAN) cable, private network cable, and wireless including wifi, Bluetooth, mobile network and the like connected to the verification server 30 and the verification report server 20. The communication means of the input device 10 includes one or more communication means for online communication with one or more servers in one or more communication ways.

Referring to FIG. 2, in the second example of the present invention, the input device 10 further includes an encryption lock 11 where the security data are stored; the encryption lock 11 has a preset encrypted activation code and a preset decryption program. To be specific, the input device 10 includes:

a pre-installed module 12 for pre-installing the encrypted activation code;

a first transmission module 13 for transmitting the encrypted activation code pre-installed in the pre-installed module 12 to the encryption lock 11 when the input device 10 activates the security data of the quality inspector of the commodity;

a first receiving module 14 for transmitting the confidential data in an encryption way after the encryption lock 11 receives and confirms the activation code of the encryption lock 11 to be correct; and

a first decryption module 15 for decrypting the security data with the preset decryption program and transmitting the security data to the verification report server 20. Moreover, the encryption lock 11 is disposed on a shell of the input device 10, and the encryption lock is connected to the input device via a USB interface.

In this example, the pre-installed module 12 pre-installs the encrypted activation code; when activating the security data, the first transmission module 13 transmits the encrypted activation code pre-installed in the pre-installed module 12 to the encryption lock 11 when the input device 10 activates the security data of the quality inspector of the commodity; the first receiving module 14 transmits the confidential data in an encryption way after the encryption lock 11 receives and confirms the activation code of the encryption lock 11 to be correct; the first decryption module 15 decrypts the security data with the preset decryption program and transmits the security data to the verification report server 20. In one embodiment, the security data of the quality inspector are pre-stored in the input device 10, and requires activation with password to be used only. In one preferable embodiment, the input password of the quality inspector is only valid within a preset specific time period, for example, the input password of the quality inspector may be only valid for ten minutes each time. After the preset specific time period, the quality inspector has to make authentication again. In one of the embodiments, the security data including the private key and the like of the quality inspector are stored within the secured encryption lock 11 (dongle). The encryption lock 11 is disposed on the external shell of the input device 10, and is connected to the input device 10 via a USB-A, a mini USB, a micro USA, a USB-C, or lighting, or other plug wires, and the encryption lock 11 is connected to a USB connector of the input device 10 with the shell of input device 10.

Preferably, the input device 10 is a mobile phone, and the encryption lock 11 is disposed on the shell of the mobile phone in a way thereof. Further, the shell includes an external battery of the mobile phone, and is manufactured into the input device 10 which is convenient for carrying and has a longer service time.

Referring to FIG. 2, in the third example of the present invention, the inspection device 100 further comprises:

at least one security encoder 40 generating a token having a time limit for the quality inspector, the token being invalid when reaching the time limit; and

The input device 10 further includes:

a first storage module 16 for storing information of the token;

a first input module 17 for inputting the token when the input device 10 activates the security data of the quality inspector of the commodity;

a first judgment module 18 for checking the token input from the first input module 17 according to the information of the token stored in the first storage module 16;

an activation module 19 for activating the security data of the quality inspector after the first judgment module 18 judges the token to be correct; and

a first transmission module 13 for transmitting the activated security data of the quality inspector to the verification report server 20.

The verification report server 20 includes:

a second receiving module 21 for receiving the activated security data of the quality inspector transmitting by the input device 10;

a second decryption module 22 for decrypting the encrypted portion with a public key corresponding to the private key, and acquiring the security data.

In this example, the security encoder 40 generates a token having a time limit for the quality inspector, and the token is invalid when reaching the time limit; the first storage module 16 of the input device 10 stores information of the token; the first input module 17 inputs the token when the input device 10 activates the security data of the quality inspector of the commodity; the first judgment module 18 checks the token input from the first input module 17 according to the information of the token stored in the first storage module 16; the activation module 19 activates the security data of the quality inspector after the first judgment module 18 judges the token to be correct; the first transmission module 13 transmits the activated security data of the quality inspector to the verification report server 20. The second receiving module 21 of the verification report server 20 receives the activated security data of the quality inspector transmitted by the input device 10; the second decryption module 22 decrypts the encrypted portion with a public key corresponding to the private key, and acquires the security data. Preferably, each quality inspector is configured with a security encoder 40 (security device) which generates a token having a time limit after activation, and the time limit may be set to 60 seconds or other time limit, i.e., the token may be only valid for 60 seconds before or after generation of the token. The input device 10 is provided with a key board with which the quality inspector inputs the token generated by the security encoder, and checks whether the token is valid. Since the input device 10 and the security encoder 40 are two independent devices, system clocks of the two devices cannot be calibrated without communication online, and the transmission time of the token shall be allowed to be earlier than the input token time of the input device 10.

Referring to FIG. 2, in the fourth example of the present invention, the security encoder 40 has a preset security encoder activation password, and the security encoder 40 is activated with the security encoder password;

after the first judgment module 18 checks the token input from the first input module 17 to be correct, the activation module 19 activates the security data of the quality inspector stored in the first storage module 16.

In this example, the security encoder has to be activated with the password of the quality inspector, and the security data of the quality inspector stored in the input device 10 can only be used after checking the token.

In the fifth example of the present invention, verification of the security data also may be further enhanced through verification of the biological feature information, the first storage module 16 stores a biological feature information base including biological feature information of the quality inspector; the input device 10 further includes:

a biological feature reading device 101 for reading biological features of the quality inspector, and judging whether the biological features of the quality inspector are consistent with the biological features in the biological feature information base stored within the first storage module 16;

the activation module 19 activates the security data when the biological feature reading device 101 judges the reads the biological features of the quality inspector to be consistent with the biological features in the biological feature information base stored within the first storage module 16. The biological feature reading device 101 includes a scanning fingerprint instrument and/or a scanning eyeball iris instrument.

In this example, the number of the quality inspector and the private key of the quality inspector (called confidential data of the quality inspector) are stored in the input device 10, and if activating and using the confidential data of the quality inspector for logging in the verification report server 20, they have to be authenticated in the input device 10. Authentication is to use the biological features additionally, except the self-defined password known to the quality inspector, as identification of identify of the quality inspector. In one of the embodiments, the biological features are input as fingerprint scanning; in another embodiment, the biological features are input as iris scanning. In order to adapt input of the biological features, the input device 10 is provided with a scanning lens of the biological features or a fingerprint scanner. In one of the embodiments, the used fingerprint scanner includes external fingerprint scanning devices, and fingerprint facilities using current mobile phones including iPhone5s or new phones, Huawei Mate S, Samsung Galaxy Note 5, and the like. In another embodiment, the input device 10 includes a lens for iris scanning, which includes scanners using Fujitsu mobile phones or external IriShield series from Iritech, Inc to read iris.

Referring to FIG. 2, in the sixth example of the present invention, the verification report server 20 further includes:

a recording module 23 for recording last logon time and address of the quality inspector; and

a second judgment module 24 for judging whether movement of the quality inspector is reasonable according to the global positioning coordinates of the input device 10, if reasonable, allowing the quality inspector to login, and if unreasonable, not allowing the quality inspector to login.

In this example, the recording module 23 record last logon time and address of the quality inspector; then, the second judgment module 24 judges whether movement of the quality inspector is reasonable according to the global positioning coordinates of the input device 10, for example, the last logon time is one hour ago, and the address is 3,000 km away from the coordinate address of the last logon, which is obviously unreasonable, so login is not allowed. In addition, different logon conditions of the verification report server 20 may also be added according to different embodiments, and the purpose is to add other mechanism, except the encryption lock 11, the security encoder 40 and the biological feature scanning, to prevent someone from pretending as the quality inspector. The logon testing conditions may include:

1. adding a logon password, which is input from the input device 10 by the quality inspector, and is encrypted with the private key as a part of the logon information, to the verification report server 20, and the verification report server 20 making comparison and confirmation;

2. recording last logon time and address of the quality inspector, and confirming, by the verification report server 20, whether movement of the quality inspector is reasonable, for example, a distance of 300 km within a time difference of one hour, i.e., the quality inspector cannot shift sites so fast within a short time, which is to further prevent the way of one quality inspector verifying at several sites, except the transmitted encryption lock 11 or the security encoder 40.

In the seventh example of the present invention, after the security data of the quality inspector pass verification, the input device 10 acquires the anti-counterfeiting code of the commodity, and transmits the anti-counterfeiting code to the verification server 30 for verification. The anti-counterfeiting code has a plurality of representing ways on the commodity. For example:

The anti-counterfeiting code of the commodity is printed on the commodity, or sticks on the commodity in a form of sticker; the anti-counterfeiting code includes optical readable characters, bar code and QR code; the input device 10 further includes:

a scanning lens or camera lens for scanning or reading the anti-counterfeiting code;

a conversion module 25 for converting the scanned anti-counterfeiting code into a digital anti-counterfeiting code; and

the first transmission module 13 transmits the converted anti-counterfeiting code to the verification server 30.

Alternatively, the anti-counterfeiting code is stored in a read only low frequency RFIDtag or stored in a rewritable high frequency RFIDtag; the input device 10 further includes:

a near field communication device for reading the anti-counterfeiting code stored in the low frequency RFIDtag, or reading the anti-counterfeiting code stored in the high frequency RFIDtag and verification status of the high frequency RFIDtag;

a conversion module 25 for converting the scanned anti-counterfeiting code into a digital anti-counterfeiting code; and

the first transmission module 13 transmits the converted anti-counterfeiting code to the verification server 30.

Alternatively, the anti-counterfeiting code is stored in a rewritable iBeacon device; the iBeacon sticks on the commodity to be damageable when removing, or is removably installed on the commodity in a separate tag or other ways; an iBeacon power supply storing the anti-counterfeiting code is charged with electricity to activate the iBeacon after damageable removing the barrier; the input device 10 further includes:

a Bluetooth read-write device for reading the anti-counterfeiting code stored in the iBeacon and updating verification status of the iBeacon device;

a conversion module 25 for converting the scanned anti-counterfeiting code into a digital anti-counterfeiting code; and

the first transmission module 13 transmits the converted anti-counterfeiting code to the verification server 30.

The first input module 17 of the input device 10 includes a keyboard and a display device, and the quality inspector inputs the anti-counterfeiting code by the keyboard. The keyboard includes a physical keyboard or a touch type keyboard which is formed of a part of positions of the display device.

In this example, the anti-counterfeiting code is printed on the commodity in a form of scannable printing form, or sticks on the commodity in a form of sticker, and includes optical readable characters, bar code and QR code, and the input device 10 includes a scanning lens or camera lens. In one of the embodiments, the anti-counterfeiting code is stored in a read only low frequency RFIDtag, and the input device 10 includes a near field communication device which reads the anti-counterfeiting code stored in the low frequency RFIDtag. In another embodiment, the anti-counterfeiting code is stored in a rewritable high frequency RFIDtag, and the input device 10 includes the near field communication device which reads and updates the anti-counterfeiting code stored in the high frequency RFIDtag and verification status of the RFIDtag. Further, in another embodiment, the anti-counterfeiting code is stored in a rewritable iBeacon device, and the input device 10 includes a Bluetooth 4.0 or above read-write device which reads and updates the verification status of the iBeacon device. Further, in order to facilitate unavailable for scanning input under the above circumstances, the input device 10 includes a keyboard and a display device, the quality inspector inputs the anti-counterfeiting code manually, and the keyboard includes a physical keyboard or a touch type keyboard which is formed of a part of positions of the display device. In one preferable embodiment, the input device 10 includes one or more devices for scanning, read-write and manual inputting.

In the eighth example of the present invention, the verification server 30 includes a first anti-counterfeiting database;

the verification server 30 searches in the first anti-counterfeiting database after receiving the anti-counterfeiting code, verifies whether the commodity represented by the anti-counterfeiting code is real, and returns a verification result to the input device 10. Moreover, preferably, the input device 10 receives the verification result of the verification server 30, displays on a display of the input device 10, and records verification record data whether the commodity is real in the input device 10. The verification record data include number of the quality inspector, verification time whether the commodity is real, satellite positioning coordinates and sea level of the input device 10 at the verification time, and verification result whether the commodity is real.

In one embodiment of the present invention, the verification result whether the commodity is real includes:

the commodity associated with the anti-counterfeiting code is not real, no such commodity;

the commodity associated with the anti-counterfeiting code has been sold but not inspected, and the commodity is real;

the commodity associated with the anti-counterfeiting code is not sold, and the commodity is not real and not sold;

the commodity associated with the anti-counterfeiting code has been sold and has been inspected, and the commodity is real, but is inspected repeatedly.

Referring to FIG. 2, in the ninth example of the present invention, the verification server 30 includes a second anti-counterfeiting database; the verification report server 20 and the verification server 30 are also used for updating verification information of the anti-counterfeiting code of the commodity synchronously in the second anti-counterfeiting database of the verification report server 20 and the first anti-counterfeiting database of the verification report server 20, respectively, after the anti-counterfeiting code of the commodity passes verification.

Specifically, the verification report server 20 includes:

a second receiving module 21 for receiving an anti-counterfeiting code preparation inspection requirement of the commodity;

a second judgment module 24 for judging whether the anti-counterfeiting code preparation inspection requirement of the commodity exists in the first anti-counterfeiting database, if existing, not adding the anti-counterfeiting code preparation inspection requirement in the first anti-counterfeiting database, and if not existing, adding the anti-counterfeiting code preparation inspection requirement in the first anti-counterfeiting database;

and, the verification server 30 includes:

a third receiving module 31 for receiving the anti-counterfeiting code preparation inspection requirement of the commodity;

a third judgment module 32 for judging whether the anti-counterfeiting code preparation inspection requirement of the commodity exists in the second anti-counterfeiting database, if existing, not adding the anti-counterfeiting code preparation inspection requirement in the second anti-counterfeiting database, and if not existing, adding the anti-counterfeiting code preparation inspection requirement in the second anti-counterfeiting database.

In this example, it needs to update anti-counterfeiting of the commodity. Till this step, the previous steps do not update the verification server 30 and the verification report server 20 which verify the commodity, so it has to ensure that updating can be made synchronously when recording the inspection process. In order to prevent non-synchronous of the verification server 30 and the verification report server 20, i.e., for the same commodity, when the verification server 30 prepares to record the verification requirement from no inspection to prepare to update and record the commodity represented by the anti-counterfeiting code as have been inspected due to the anti-counterfeiting code read by the input device 10, the verification report server 20 has to record the commodity as have been inspected synchronously and presented in the specific report. If the databases of the two servers are ensured to succeed in updating synchronously, or fail to update synchronously, or be capably of recording errors occurred in updating in different environment because the verification server 30 and the verification report server 20 may be different computer hardwares installed with the same computer hardware and the same data center, or installed in different data centers, it requires the system personal to follow up.

In one of the embodiments, as for two phase commit (2PC) program used in update of the database, the two phase commit may utilize the available database engine which supports cloud, and uses simpler program language. In order to facilitate illustration, one of the embodiments can provide distributed synchronous database update independent of the database engine, i.e., using commodity anti-counterfeiting update program 1.5.1. In another embodiment, the used database engine can provide distributed synchronous database update, and program writing is simpler, such as, using commodity anti-counterfeiting update program 1.5.2. Further, it may also use other operate mode of database synchronous update.

Referring to FIG. 2, in the tenth example of the present invention, the verification server 30 further includes:

a first searching module 33 for searching corresponding anti-counterfeiting code record with the anti-counterfeiting code of the commodity in the first anti-counterfeiting database of the verification server 30, downloading the anti-counterfeiting code record searched in the first anti-counterfeiting database to the first storage module of the input device 10, and storing as data record before update of the anti-counterfeiting code;

a first updating module 34 for updating the anti-counterfeiting code of the commodity in the first anti-counterfeiting database of the verification server 30, and updating the record successfully when the searched anti-counterfeiting code record is consistent with the anti-counterfeiting data record after update stored in the input device.

The verification server 30 further includes:

a second searching module 35 for searching the anti-counterfeiting code record with the anti-counterfeiting code in the first anti-counterfeiting database; and

a first replying module 36 for replying updating successful or unsuccessful result to the input device after comparing the searched result with the anti-counterfeiting data stored in the input device.

In the tenth example of the present invention, the first storage module of the input device 10 stores anti-counterfeiting data log record;

the verification server 30 further includes:

an establishing module 37 for establishing an anti-counterfeiting data log database and an anti-counterfeiting report data log database in the verification server 30;

a third searching module 38 for searching with the anti-counterfeiting code and number of the quality inspector in the anti-counterfeiting data log database, and when the search result is one or more records, finding out whether the one or more records is consistent with the anti-counterfeiting data log record; and

a first deleting module 39 for deleting the one or more records when the one or more records is consistent with the anti-counterfeiting data log record.

Referring to FIG. 2, in the eleventh example of the present invention, the verification report server 20 further includes:

a fourth searching module 36 for searching record of the anti-counterfeiting code preparation inspection requirement with the anti-counterfeiting code in the first anti-counterfeiting database after the first anti-counterfeiting database fails to add the anti-counterfeiting code preparation inspection requirement; and

a second deleting module 27 for deleting the record of the anti-counterfeiting code preparation inspection requirement in the first anti-counterfeiting database when the record of the anti-counterfeiting code preparation inspection requirement is searched by the fourth searching module 26, and the number of the quality inspector in the record is the same as the number of the quality inspector who operates the input device.

In the twelfth example of the present invention, the verification server 30 further includes:

a fourth searching module 301 for searching record of the anti-counterfeiting code preparation inspection requirement with the anti-counterfeiting code in the second anti-counterfeiting database after the second anti-counterfeiting database fails to add the anti-counterfeiting code preparation inspection requirement; and

a second deleting module 302 for deleting the record of the anti-counterfeiting code preparation inspection requirement in the second anti-counterfeiting database when the record of the anti-counterfeiting code preparation inspection requirement is searched by the fourth searching module 26, and the number of the quality inspector in the record is the same as the number of the quality inspector who operates the input device.

In this example, commodity anti-counterfeiting update-self-coding two phase commit program (1.5.1)

In order to achieve synchronous update, a method of two phase commit is used in one of the embodiments, and some commercial database tools are provided with different basic programs to support synchronous update of database distributed with different servers. Here below is the way of configuring two phase commit in one of the embodiments, and the steps are as follows:

The First Phase: Commit Request Phase

Step 1. Add one record of the anti-counterfeiting code preparation inspection requirement in the verification server 30, and the anti-counterfeiting code preparation inspection requirement includes the following information:

the anti-counterfeiting code;

the number of the quality inspector;

a clock of the verification server 30;

As for searching the anti-counterfeiting code preparation inspection requirement respectively in the first and second anti-counterfeiting databases, the anti-counterfeiting code of the commodity is a unique search key, i.e., if the first and second anti-counterfeiting databases already have the same anti-counterfeiting code record, the record cannot be added, and under such circumstance, i.e., another program has added this record, i.e., another program is inspecting while not completing the entire update program. If the anti-counterfeiting code preparation inspection requirement has a certain anti-counterfeiting code record in the first and second anti-counterfeiting databases, it means that the anti-counterfeiting code is in the inspection process; and unsuccessful of adding the anti-counterfeiting code preparation inspection requirement is to prevent two inspectors from updating the record of the same anti-counterfeiting code synchronously.

Step 2. If adding the record of the anti-counterfeiting code preparation inspection requirement in step 1 is not successful, return to step 1. If repetition of step 1 exceeds a first predetermined times, jump to step 6. In one of the embodiments, the first predetermined times is five.

Step 3. Add one record of the anti-counterfeiting code preparation report requirement in the verification report server 20, the anti-counterfeiting code preparation report requirement includes the following information:

the anti-counterfeiting code;

the number of the quality inspector;

a clock of the verification report server 20;

The second receiving module 21 receives the anti-counterfeiting code preparation inspection requirement of the commodity transmitted by the input device 10, the second judgment module 24 judges whether an anti-counterfeiting code preparation report requirement of the commodity exists in the first anti-counterfeiting database, the anti-counterfeiting code preparation report requirement is in the first anti-counterfeiting database, and the anti-counterfeiting code of the commodity is an unique search key, i.e., if the first anti-counterfeiting database (which may also be called an anti-counterfeiting code preparation report requirement database) already has the same anti-counterfeiting code record, the record cannot be added, and under such circumstance, i.e., another program has added the record, i.e., another program is inspecting the report while not completing the entire update program. If the first anti-counterfeiting database has a certain anti-counterfeiting code record, it means that the anti-counterfeiting code is in the inspection process; unsuccessful of adding the anti-counterfeiting code preparation report requirement is to prevent two inspectors from updating the report record of the same anti-counterfeiting code synchronously. Similarly, the third receiving module 31 receives the anti-counterfeiting code preparation inspection requirement of the commodity; and the third judgment module 32 judges whether the anti-counterfeiting code preparation inspection requirement of the commodity exists in the second anti-counterfeiting database, i.e., if the second anti-counterfeiting database (which may also be called the anti-counterfeiting code preparation report requirement database) already has the same anti-counterfeiting code record, the record cannot be added.

Step 4. If adding the record of the anti-counterfeiting code preparation report requirement in step 2 is not successful, return to step 3. If repetition of step 3 exceeds a second predetermined times, jump to step 6. In one of the embodiments, the second predetermined times is five.

Step 5. The above steps 1-4 succeed in adding the record of the anti-counterfeiting code preparation inspection requirement in the verification server 30, and adding the record of the anti-counterfeiting code preparation report requirement in the verification report server 20, i.e., the two servers have prepared for the commit request phase. Enter the second phase, i.e., jump to step 10.

Step 6. At least one of the above steps 1-4 fails, i.e., the commit request of the first phase of program fails, clearly rollback the update program without leaving any trace. At this phase, the record of the anti-counterfeiting code preparation inspection requirement may be added in the verification server 30, or the record of the anti-counterfeiting code preparation report requirement may be added in the verification report server 20, so leave after clearing.

Step 7. Search, by the fourth searching module 26, with the anti-counterfeiting code in the anti-counterfeiting code preparation inspection requirement database, if existing that the number of the quality inspector who operates the input device 10 is consistent with the number of the quality inspector searched in the second anti-counterfeiting database, the second deleting module 302 removes the searched record from the anti-counterfeiting code preparation inspection requirement database.

Step 8. Search with the anti-counterfeiting code in the first anti-counterfeiting database of the verification report server 20, if existing that the number of the quality inspector who operates the input device 10 is consistent with the number of the quality inspector searched in the first anti-counterfeiting database, remove the searched record from the first anti-counterfeiting database.

Step 9. Transmit a wrong message to the input device 10, indicating that other inspector inspects the commodity with the same anti-counterfeiting code at the same time, which may be a system error, and requires the system personnel of the verification server 30 to investigate and correct; and may also be the same anti-counterfeiting code because the anti-counterfeiting code is stolen, and the first phase of program fails, rollback program 1.5.1 and do not enter into the second phase.

The Second Phase: Commit Phase

Enter into the second phase, i.e., the database may be updated.

Step 10. Search the single anti-counterfeiting code record with the anti-counterfeiting code in the second anti-counterfeiting database of the verification server 30, download the searched record of the whole database to the input device 10, store as an anti-counterfeiting data record before update, and prepare to update the data as in the following table one:

TABLE ONE

| | |
|---|---|
| data field name | anti-counterfeiting data record after update |
| the anti-counterfeiting | unchanged with the anti-counterfeiting data |
| code | record before update |
| sales time of the | unchanged with the anti-counterfeiting data |
| commodity | record before update |
| initial inspection time | if the original anti-counterfeiting data |
| of the commodity | record before update is null, update as a |
| | system clock of the verification server 30, |
| | otherwise, keep unchanged |
| inspection times of the | add one to the anti-counterfeiting data |
| commodity | record before update |

The anti-counterfeiting data record after update is stored in the input device 10, and an instruction is transmitted to the anti-counterfeiting database of the verification server 30 to update the record.

Step 11. Confirm successful of updating the record in step 10: in one of the embodiments, search the single anti-counterfeiting record with the anti-counterfeiting code in the second anti-counterfeiting database of the verification server 30, if the search result is consistent with the anti-counterfeiting data record after update stored in the input device 10, i.e., succeed in updating the record in step 10. In another embodiment, the instruction of updating the record transmitted to the verification server 30 in step 10 will get a response of successful or unsuccessful result. If the result of updating the record in step 10 is unsuccessful, go to step 20.

Step 12. Write the anti-counterfeiting data log: the establishing module 37 establishes the anti-counterfeiting data log database in the verification server 30:

TABLE TWO

| | |
|---|---|
| data field name | anti-counterfeiting data log record |
| the anti-counterfeiting | unchanged with the anti-counterfeiting |
| code | data record before update |
| the number of the quality | data authenticated by the input device 10 |
| inspector | |
| verification result | verification result acquired in step 4, |
| | program 1.4 |
| verification time | verification time acquired in step 4, |
| | program 1.4 |

The anti-counterfeiting data log record is stored in the input device 10, and an instruction is transmitted to the anti-counterfeiting data log database of the verification server 30 to update the record.

Step 13. Confirm successful of updating the record in step 12: in one of the embodiments, search, by the third searching module 38, the record with the anti-counterfeiting code and the number of the quality inspector in the second anti-counterfeiting database (the anti-counterfeiting data log database) of the verification server 30, if the searched result is one or more records, finding out whether the searched record is consistent with the anti-counterfeiting data log record stored in the input device 10, i.e., succeed in updating the record in step 12. In another embodiment, the instruction of updating the record transmitted to the verification server 30 in step 12 will get a response of successful or unsuccessful result. If the result of updating the record in step 12 is unsuccessful, go to step 20.

Step 14. Write the anti-counterfeiting report data log record: firstly, acquire the commodity data represented by the anti-counterfeiting code, search with the commodity model of the anti-counterfeiting record acquired in step 10 of this program in the commodity database of the verification server 30, and acquire the commodity record, i.e., acquire the commodity producer and the commodity name in the commodity record.

The establishing module 37 establishes the verification report log database in the verification server 30:

TABLE THREE

| | |
|---|---|
| data field name | verification report log record |
| the number of the quality | data authenticated by the input device 10 |
| inspector | |
| verification time | verification time acquired in step 4, |
| | program 1.4 (including second, minute, |
| | hour, date, month and year) |
| satellite positioning | satellite positioning coordinates |
| coordinates when | (including sea level) acquired in step 4, |
| verifying | program 1.4 |
| the anti-counterfeiting | unchanged with the anti-counterfeiting |
| code | data record before update |
| the commodity model | the commodity model acquired from the |
| | anti-counterfeiting data record |
| the commodity producer | the commodity producer acquired from |
| | the commodity record |
| the commodity name | the commodity name acquired from the |
| | commodity record |
| verification result | verification result acquired in step 4, |
| | program 1.4 |

The verification report log record is stored in the input device 10, and an instruction is transmitted to the verification report log database of the verification report server 20 to add the record.

Step 15. Confirm successful of adding the record in step 14: in one of the embodiments, search the record with the anti-counterfeiting code and the number of the quality inspector in the second anti-counterfeiting database of the verification server 30, if the searched result is one or more records, finding out whether the searched record is consistent with the verification report log record stored in the input device 10, i.e., succeed in updating the record in step 12. In another embodiment, the adding instruction transmitted to the verification server 30 in step 12 will get a response of successful or unsuccessful result. If the result of adding the record in step 14 is unsuccessful, go to step 20.

Step 16. Confirm all updates at the commit phase to be successfully, i.e., if the results in steps 11, 13 and 15 are confirmed all successful, unlock settings at the commit request phase of the first phase.

Step 17. Unlock the anti-counterfeiting code preparation inspection requirement of the verification server 30: search the second anti-counterfeiting database with the anti-counterfeiting code stored in the input device 10, read the single record, and delete, by the first deleting module 39, the searched record from the second anti-counterfeiting database.

Step 18. Unlock the anti-counterfeiting code preparation report requirement of the verification report server 20: search, by the fourth searching module 26, the first anti-counterfeiting database with the anti-counterfeiting code stored in the input device 10, read, by the second deleting module 27, the single record, and delete the searched record from the database.

Step 19. Complete this phase successfully.

Step 20. If one or more databases at this phase fails to update or add the record, clear the record.

Step 21. Search the single anti-counterfeiting record with the anti-counterfeiting code in the second anti-counterfeiting database of the verification server 30, and if the searched result is consistent with the anti-counterfeiting data record after update stored in the input device 10, i.e., succeed in updating the record in step 10, clear the update in step 10. Change the searched record in the second anti-counterfeiting database of the verification server 30 to the anti-counterfeiting data record before update stored in the input device 10, and transmit the update instruction to the second anti-counterfeiting database of the verification server 30.

Step 22. Search with the anti-counterfeiting code and the number of the quality inspector in the anti-counterfeiting data log record of the verification server 30, if the searched result is one or more records, find out whether the searched record is consistent with the anti-counterfeiting data log record stored in the input device 10, i.e., succeed in updating the record in step 12, make clearance, and transmit an instruction of deleting the anti-counterfeiting data log record of the verification server 30 to the verification server 30.

Step 23. Search with the anti-counterfeiting code and the number of the quality inspector in the verification report log record of the verification report server 20, if the searched report log record is consistent, i.e., succeed in adding the record in step 14, make clearance, and transmit an instruction of deleting the verification report log record of the verification report server 20 to the verification report server 20.

Step 24. Unlock the anti-counterfeiting code preparation inspection requirement of the verification server 30: carry out step 17.

Step 25. Unlock the anti-counterfeiting code preparation report requirement of the verification report server 20: carry out step 18.

Step 26. Complete this phase unsuccessfully.

Commodity anti-counterfeiting update-utilizing the database engine to simplify two phase commit program (1.5.2) for coding.

In another embodiment, the database engine provides two phase commit, the two phase commit may be directly controlled with a more advanced program language, and the steps are as follows:

Step 31. Begin transaction;

Step 32. Search with the anti-counterfeiting code in the first anti-counterfeiting database of the verification server 30, and require read-lock settings for the searched record, i.e., other program reads the searched record only, and no writable.

Step 33. Update the acquired record of the first anti-counterfeiting database of the verification server 30 searched with the anti-counterfeiting code (referring to program 1.5.1, step 10).

Step 34. Add the anti-counterfeiting data log record in the second anti-counterfeiting database of the verification server 30 (referring to program 1.5.1, step 12).

Step 35. Add the verification report log data in the first anti-counterfeiting database of the verification report server 20 (referring to program 1.5.1, step 14).

Step 36. If any step 33, 34 or 35 is false, rollback, i.e., automatically reply all updates of steps 32, 33 and 34; unlock the read-lock settings in step 32; result is false, transaction ends and completes.

Step 37. Unlock the read-lock settings in step 32; result is false, transaction ends and completes.

In one example of the present invention, the inspection goods program (program one): steps in details

According to above explanations, the complete inspection goods program is:

Step 41. Turn on the input device 10;

Step 42. Activate the security data of the quality inspector (program 1.1, i.e., the method of protecting the security data of the quality inspector used according to different embodiments, execute program 1.1.1, 1.1.2 or 1.1.3);

Step 43. Connect the input device 10 to the verification report server 20, transmits requirement for logging in the verification report server 20, and sends request login information according to the security data of the quality inspector acquired in step 2,;

Step 45. Receive, by the verification report server 20, the request login information from the input device 10, compare the database of the quality inspector of the verification report server 20, check that the number of the quality inspector of the unencrypted portion within the request login information actually exists in the database, and require authentication from the certificate authority (CA) of the public key infrastructure, the request authentication information including the encrypted portion of the request login information transmitted by the input device 10;

Step 46. In one preferable embodiment, the verification report server 20 is a certificate authority of the public key infrastructure, or a registration authority, and the verification report server 20 self-authenticates the request login information.

Step 47. According to step 45 or 46, decrypt the encrypted portion within the request login information with the public key acquired from the public key infrastructure, record other data of the request login information, store the public key of the quality inspector for the use of communication conversation;

Step 48. In one of the embodiments, further check the request login information of the quality inspector, and execute program 1.2 (test whether the request login information is abnormal);

Step 49. Carry out the inspection good program after logging in the verification report server 20 is completed.

Step 410. Due to different manufacturing ways of the anti-counterfeiting codes of different commodities, execute different programs 1.3.1, 1.3.2 or 1.3.3 in the anti-counterfeiting code reading program 1.3 to read the anti-counterfeiting codes, and transmit the anti-counterfeiting codes to the verification server 30;

Step 411. Execute program 1.4 to confirm the authenticity of the commodity represented by the anti-counterfeiting code; if the commodity represented by the anti-counterfeiting code is counterfeit, still continue recording the log of verifying the counterfeit;

Step 412. Execute program 1.5 to make the commodity anti-counterfeiting update. In different embodiments, execute program 1.5.1 to self-ensure synchronization of the database, and execute program 1.5.2 to ensure synchronous updating of the database utilizing function of the specific database engine or other program.

Step 413. Complete updating, if next commodity needs to be verified, go to step 410, otherwise, complete.

In one example of the present invention, it needs to inspect the goods report after the commodity inspection is completed.

After the inspection is completed, the quality inspector may self-request the report from the verification report server 20. The creation of the report is searched in the verification report log database of the verification report server 20, includes record of the specific quality inspector with selected specific dates, and is listed in different arrangements and selecting ways. In one of the embodiments, the verification report includes report one. The purpose achieved by report one includes confirming the listed anti-counterfeiting codes to be verified with the input device 10 used by the quality inspector, and the satellite positioning coordinates and time recorded when inspection starts, which is to further prevent the quality inspector from recording real at another place as inspection at the site.

Further, in another embodiment, now report one may increase or reduce items in the report, including verification result, etc. On the other hand, it also may filter record with different selections, for example, in one of the embodiments, report one only lists abnormal inspection results, including no such commodity, not selling the commodity, repeatedly verifying the commodity, etc.

Referring to FIG. 4, in the thirteenth example of the present invention, it provides an inspection method utilizing the inspection device 100 provided in the above several examples, the method comprising:

Step S301: the input device 10 activates security data of a quality inspector of the commodity, transmits the security data to the verification report server 20 for verification, reads an anti-counterfeiting code of the commodity after the security data pass verification, and transmits the anti-counterfeiting code to the verification server 30;

Step S302: the verification report server 20 receives the security data and verifies the security data; and

Step S303: the verification server 30 receives the anti-counterfeiting code of the commodity to verify the anti-counterfeiting code.

In this example, the quality inspector of the commodity has security data for the function of identification of identity to ensure the quality inspector who has permission to inspect the commodity. Moreover, these security data are activated by the input device 10, and transmitted to the verification report server 20 which verifies these security data. After the security data pass verification, the input device 10 reads an anti-counterfeiting code of the commodity, and transmits the anti-counterfeiting code of the commodity to the verification server 30 to verify the anti-counterfeiting code, wherein the security data includes an unencrypted portion and an encrypted portion; the unencrypted portion includes number of the quality inspector; the encrypted portion includes the number of the quality inspector, global positioning coordinates of the input device 10, logon time of the input device 10 and number of the input device 10, which are encrypted using a private key; after the input device 10 activates the security data and transmits the security data to the verification report server 20, the verification report server 20 decrypts the encrypted portion with a public key corresponding to the private key, and acquires the security data. The input device 10 further includes an encryption lock 11 where the security data are stored; the encryption lock 11 having a preset encrypted activation code and a preset decryption program. As to the anti-counterfeiting code of the commodity, it is input from the input device 10. The input device 10 includes a keyboard and a display device, the quality inspector inputs the anti-counterfeiting code by the keyboard. The keyboard includes a physical keyboard or a touch type keyboard which is formed of a part of positions of the display device.

In addition, the input device 10 is communicatively connected to the verification report server 20 and the verification server 30, respectively; the input device 10 is wired or wireless communicatively connected to the verification server 30 and the verification report server 20, respectively. The wireless communicatively connection includes WIFI network connection, Bluetooth connection or mobile network connection.

In one embodiment of the present invention, the step that the input device 10 activates the security data of the quality inspector of commodity and transmits the security data to the verification report server 20 for verification comprises:

pre-installing, by the input device 10, the encrypted activation code;

transmitting the pre-installed encrypted activation code to the encryption lock 11 when the input device 10 activates the security data of the quality inspector of the commodity;

transmitting the confidential data to the input device 10 in an encryption way after the encryption lock 11 receives and confirms the activation code of the encryption lock 11 to be correct, decrypting, by the input device 10, the security data with the preset decryption program and transmitting the security data to the verification report server 20 for verification. The encryption lock 11 is connected to the input device 10 via a USB interface, and the encryption lock 11 is a shell type phone.

In the fourteenth example of the present invention, the inspection device 100 further comprises at least one security encoder 40 generating a token having a time limit for the quality inspector, the token being invalid when reaching the time limit;

the step that the input device 10 activates the security data of the quality inspector of commodity and transmits the security data to the verification report server 20 for verification further comprises:

storing, by the input device 10, information of the token;

inputting the token when the input device 10 activates the security data of the quality inspector of the commodity;

checking, by the input device 10, the input token according to the information of the token, activating, by the input device 10, the security data of the quality inspector after judging the token to be correct; and transmitting the activated security data of the quality inspector to the verification report server 20.

In the fifteenth example of the present invention, the security encoder 40 has a preset security encoder activation password, and the security encoder 40 is activated with the security encoder password;

activating the stored security data of the quality inspector after the input device 10 checks the input token to be correct.

In the sixteenth example of the present invention, the input device 10 stores a biological feature information base including biological feature information of the quality inspector, and the input device 10 further includes a biological feature reading device 101;

the step that the input device 10 activates the security data of the quality inspector of the commodity and transmits the security data to the verification report server 20 for verification further comprises:

reading, by the biological feature reading device 101, biological features of the quality inspector, and judging whether the biological features of the quality inspector are consistent with the biological features in the biological feature information base; and

activating, by the input device 10, the security data when the biological feature reading device 101 judges and reads the biological features of the quality inspector to be consistent with the biological features in the biological feature information base.

The biological feature reading device includes a scanning fingerprint instrument and/or a scanning eyeball iris instrument.

In the seventeenth example of the present invention, the step S302 comprises:

receiving, by the verification report server 20, the activated security data of the quality inspector transmitted by the input device 10; and

decrypting, by the verification report server 20, the encrypted portion with a public key corresponding to the private key, and acquiring the security data.

In this example, inspection of the commodity has to decrypt the security data of the quality inspector. Specifically, the inspection good program (program one):

The quality inspector turns on the input device 10, activates the security data of the quality inspector (program 1.1), and logins the verification report server 20, and the logon data include logon requirement of the encrypted portion with the private key of the quality inspector in the public key infrastructure, the request login information:

1. the unencrypted portion: the number of the quality inspector;

2. the portion encrypted with the private key:

a. the number of the quality inspector (repeated message);

b. global positioning coordinates (longitude, latitude and sea level) of the current input device 10;

c. logon time;

d. the number of the input device 10.

The verification report server 20 receives the request login information to search the public key of the quality inspector with the number of the quality inspector, and uses the public key to decrypt the encrypted portion of the request login information. If the request login information is normal (program 1.2), a communication conversion with the input device 10 may be established.

The quality inspector selects the storing way of the anti-counterfeiting code used by the commodity to be inspected, selects that the input device 10 uses a scanning lens, a near field communication device, a Bluetooth device or a keyboard as steps for the anti-counterfeiting code reading program (program 1.3), transmits a search request to the verification server 30 with the anti-counterfeiting code after reading the anti-counterfeiting code, and confirms that the commodity represented by the anti-counterfeiting code is real and the commodity anti-counterfeiting may be updated. After updating of the commodity anti-counterfeiting is completed, the recorded represented by the anti-counterfeiting code in the verification server 30 has been inspected, and the inspection time, address and data of the quality inspector have been recorded. At the same time, the verification report server 20 newly adds one record for the use of making the verification report.

Activation of the Security Data of the Quality Inspector (Program 1.1)

The activation program is different with the difference of the storing way of the security data of the quality inspector. The quality inspector has to activate the security data, and has to use auxiliary of the encryption lock 11 (dongle) or the security encoder 40 to complete the activation program. In the prior art, the encryption lock 11 and the security encoder 40 are widely used in China and international banks, and are difficult to be counterfeited or duplicated, i.e., they can prevent one quality inspector from duplicating the encryption lock 11 or the security encoder 40, wherein one of them is a counterfeited quality inspector. In addition, it also may use unique biological features to distinguish the quality inspectors.

Activation of the security data of the quality inspector (program 1.1.1)—using the encryption lock 11 (dongle). The number of the quality inspector and the private key of the quality inspector (called confidential data of the quality inspector) are stored in the encryption lock 11. In one of the embodiments, the encryption lock 11 is the only encryption lock 11 transmitted by the verification report server 20, and it requires a preset password (an activation code of the encryption lock 11, in one of the embodiments, the activation code is 256 bit password, and when the quality inspector is configured with the encryption lock 11, the activation code of the encryption lock 11 is also configured and installed within the input device 10 when disposing the input device 10) and a particular program to read the encryption lock 11. When installing and setting the input device 10, on the premise of particular verification, the activation code of the encryption lock 11 and the particular program are downloaded for connecting with the encryption lock 11 and reading the data within the encryption lock 11. The encryption lock 11 is connected to the input device 10 provided with a USB interface via different standards of USB interfaces, and the USB interface includes a USB-A, a mini-USB, a micro-USB, a USB-C, a USB type 3, lighting or other USB forms. Further, the encryption lock 11 may be a shell of iPhone5 or iPhone6 connecting with mobile phones of iPhone5, iPhone5S, iPhone6, iPhone6 plus and the like via the lighting interface, or the encryption lock 11 may be a shell of Samsung or Huawei connecting with various models of Samsung or Huawei mobile phones via the micro-USB interface. The shell type encryption lock 11 of the mobile phones is convenient for carrying the entire input device 10, and the input device becomes a single device without other external devices. Further, the shell may also add a backup battery to prolong service time of the input device 10. The encryption lock 11 needs a password to be activated, and transmits stored data to the input device 10.

In one preferable example, as for logon program of the quality inspector, it includes:

Step 1: the input device 10 prepares the password of the input device 10 of the quality inspector, and the logon program of the quality inspector of the input device 10 initiates when the password is correct;

Step 2: the input device 10 activates the encryption lock 11, and transmits the activation code of the encryption lock 11 which has been installed in the input device 10 as the activation code encryption lock 11 to the encryption lock 11;

Step 3: the encryption lock 11 transmits the security data of the quality inspector to the input device 10 after receiving and confirming the activation code of the encryption lock 11 to be correct;

Step 4: the input device 10 uses the particular program to decrypt the security data of the quality inspector, and prepares to login the verification report server 20.

In the eighteenth example of the present invention, the step S302 further comprises:

recording, by the verification report server 20, last logon time and address of the quality inspector; and

judging, by the verification report server 20, whether movement of the quality inspector is reasonable according to the global positioning coordinates of the input device, if reasonable, allowing the quality inspector to login, and if unreasonable, not allowing the quality inspector to login.

In this example, the movement of the quality inspector may be judged whether reasonable according to last logon time and address of the quality inspector, and the global positioning coordinates of the input device 10. For example, it is half hour from the last logon time, and it is judged that the quality inspector moves 200 km according to the global positioning coordinates, so it is obviously unreasonable, and it may have the circumstance of illegal login. Thus, the quality inspector is not allowed to login.

In one embodiment of the present invention, activation of the security data of the quality inspector (program 1.1.2)—the security encoder 40; the number of the quality inspector and the private key of the quality inspector (called confidential data of the quality inspector) are stored in the input device 10, and if activating and using the confidential data of the quality inspector for logging in the verification report server 20, they have to be authenticated in the input device 10. Authentication is to use the token having a time limit generated by the security encoder 40 additionally, except the self-defined password known to the quality inspector. In one of the embodiments, the security encoder 40 is the only encoder transmitted by the verification report server 20. When presetting the input device 10 and the security encoder 40, the verification report server 20 matches the security encoder 40 transmitted by the verification report server 20, and record a difference of the system clocks of the two devices. In one of the embodiments, the security encoder 40 is the one produced by Vasco Data Security N.V. according to DIGIPASS 270. The process includes:

Step 1: the input device 10 prepares the password of the input device 10 of the quality inspector, and the logon program of the quality inspector of the input device 10 initiates when the password is correct;

Step 2: the quality inspector initiates the security encoder 40, and in one of the embodiments, the security encoder 40 needs an input password to display the token of the security encoder 40; in another embodiment, the security encoder 40 does not need the input password to have displayed the token of the security encoder 40;

Step 3: the quality inspector inputs the token generated by the security encoder 40 into the input device 10 to complete the initiate program of the input device 10, and prepare the confidential data of the quality inspector;

Step 4: the input device 10 uses the confidential data of the quality inspector, and prepares to login the verification report server 20.

Activation of the Security Data of the Quality Inspector (Program 1.1.3)—the Security Encoder 40

Step 1: the input device 10 prepares the password of the input device 10 of the quality inspector, and the logon program of the quality inspector of the input device 10 initiates when the password is correct;

Step 2: in one of the embodiments, the input device 10 initiates the fingerprint scanner to read the fingerprint, and confirms the identity of the quality inspector; in another embodiment, the input device 10 initiates the iris scanner to read the iris, and confirms the identity of the quality inspector;

Step 3: the input device 10 prepares the confidential data of the quality inspector after confirming the identity;

Step 4: the input device 10 uses the confidential data of the quality inspector, and prepares to login the verification report server 20.

In the nineteenth example of the present invention, the anti-counterfeiting code of the commodity is printed on the commodity, or sticks on the commodity in a form of sticker; the anti-counterfeiting code includes optical readable characters, bar code and QR code;

the input device 10 further includes a scanning lens or camera lens; the step of reading the anti-counterfeiting code of the commodity after the security data pass verification, and transmitting the anti-counterfeiting code to the verification server 30 comprises:

scanning or reading, by the scanning lens or camera lens of the input device 10, the anti-counterfeiting code of the commodity;

converting, by the input device 10, the scanned anti-counterfeiting code into a digital anti-counterfeiting code; and

transmitting, by the input device 10, the converted anti-counterfeiting code to the verification server 30. Or,

in one embodiment of the present invention, the anti-counterfeiting code is stored in a read only low frequency RFIDtag or stored in a rewritable high frequency RFIDtag;

the input device 10 further includes a near field communication device; the step of reading the anti-counterfeiting code of the commodity after the security data pass verification, and transmitting the anti-counterfeiting code to the verification server 30 comprises:

reading, by the near field communication device of the input device 10, the anti-counterfeiting code stored in the low frequency RFIDtag, or the anti-counterfeiting code stored in the high frequency RFIDtag and verification status of the high frequency RFIDtag on the commodity;

converting, by the input device 10, the scanned anti-counterfeiting code into a digital anti-counterfeiting code; and

transmitting, by the input device 10, the converted anti-counterfeiting code to the verification server 30. Or,

in one embodiment of the present invention, the anti-counterfeiting code is stored in a rewritable iBeacon device; the iBeacon sticks on the commodity to be damageable when removing, or is removably installed on the commodity in a separate tag or other ways; an iBeacon power supply storing the anti-counterfeiting code is charged with electricity to activate the iBeacon after damageable removing the barrier;

the input device 10 further includes a Bluetooth read-write device; the step of reading the anti-counterfeiting code of the commodity after the security data pass verification, and transmitting the anti-counterfeiting code to the verification server 30 comprises:

reading, by the Bluetooth read-write device of the input device 10, the anti-counterfeiting code stored in the iBeacon and updating verification status of the iBeacon device;

converting, by the input device 10, the scanned anti-counterfeiting code into a digital anti-counterfeiting code; and

transmitting, by the input device 10, the converted anti-counterfeiting code to the verification server 30.

In this example, there are a plurality of ways for the input device 10 to read the anti-counterfeiting code of the commodity, and according to different existence forms of the anti-counterfeiting code, the input device 10 adopts different reading devices to read. Moreover, in another embodiment, the input device 10 includes biological feature reading devices including scanning fingerprint or eyeball iris. The input device 10 may record the inspection address, i.e., recording the checking site of the anti-counterfeiting code. The input device 10 includes a global positioning system (GPS) or other positioning devices. The input device 10 includes a built-in clock, and further, the built-in clock can be connected to the time server utilizing the netword of the input device 10 to calibrate the clock.

In one embodiment of the present invention, step 1: test whether login of the quality inspector is abnormal according to the above conditions.

Reading the anti-counterfeiting code (program 1.3.1)—the anti-counterfeiting code may be stored in a scannable printing form; the anti-counterfeiting code is recorded in a printed way, and may be directly printed on the commodity, for example, printed on the commodity including bathroom component, prefabricated aluminum window and the like in a way of laser or casting. In one of the embodiments, the anti-counterfeiting code is covered with a sticker for protection to be damageable when removing, i.e., the quality inspector has to confirm that the sticker to be damageable when removing is not removed before inspection. In another embodiment, the anti-counterfeiting code is printed on a sticker, and the printing is covered by a sticker to be damageable when removing. The sticker of the anti-counterfeiting code may stick on the commodity, or attached to the commodity in a form of external tag. The detailed reading process of the anti-counterfeiting code includes:

Step 1. Initiate the lens device of the input device to prepare the anti-counterfeiting code which is scanned and printed;

Step 2. In one of the embodiments, the quality inspector initiates the camera function to use the lens to shoot the sticker covering the printed anti-counterfeiting code;

Step 3. The quality inspector tears the protective sticker to be damageable when removing;

Step 4. The quality inspector initiates the camera function to use the lens to scan the anti-counterfeiting code;

Step 5. The input device 10 converts the scanned anti-counterfeiting code into a digital one, and transmits the anti-counterfeiting code to the verification server 30;

Steps of reading the anti-counterfeiting code program (program 1.3.2)—the anti-counterfeiting code is stored in the low or high frequency RFIDtag;

The anti-counterfeiting code is stored in the RFIDtag which includes low or high frequency RFIDtag, and the RFIDtag damageable sticks on the commodity when removing, and may also be removably installed on the commodity in a separate tag or other ways.

Step 1. Initiate the low or high frequency reading device of the near field communication device of the input device 10;

Step 2. The quality inspector initiates the near field communication reading device to read the anti-counterfeiting code stored in the RFIDtag;

Step 3. The input device 10 converts the read anti-counterfeiting code into a digital one, and transmits the anti-counterfeiting code to the verification server 30;

Step of reading the anti-counterfeiting code program (program 1.3.3)—the anti-counterfeiting code is stored within a Bluetooth device iBeacon.

The anti-counterfeiting code is stored within the iBeacon. In one of the embodiments, the anti-counterfeiting code is a unique identifier (UUID) of the Bluetooth device iBeacon, and the unique identifier consists of a major code proximity the unique identifier and a minor code. In another embodiment, the anti-counterfeiting code is stored within the Bluetooth device iBeacon. The iBeacon sticks on the commodity to be damageable when removing, and may also be removably installed on the commodity in a separate tag or other ways. In one of the embodiments, the iBeacon power supply storing the anti-counterfeiting code is charged with electricity to activate the iBeacon after damageable removing the barrier. The detailed reading process of the anti-counterfeiting code includes:

Step 1. Initiate the Bluetooth read-write device of the input device 10;

Step 2. In one of the embodiments, the quality inspector activates the iBeacon after damageable removing the barrier;

Step 3. The quality inspector initiates the Bluetooth read-write device to read the anti-counterfeiting code stored in the iBeacon;

Step 4. The input device 10 converts the read anti-counterfeiting code into a digital one, and transmits the anti-counterfeiting code to the verification server 30.

In the twentieth example of the present invention, the verification server 30 includes a first anti-counterfeiting database; the step S303 comprises:

searching in the first anti-counterfeiting database after the verification server 30 receives the anti-counterfeiting code, verifying whether the commodity represented by the anti-counterfeiting code is real, and returning a verification result to the input device 10. Moreover, the input device 10 receives the verification result of the verification server 30, displays on a display of the input device 10, and records verification record data whether the commodity is real in the input device 10. The verification result whether the commodity is real includes:

the commodity associated with the anti-counterfeiting code is not real—no such commodity;

the commodity associated with the anti-counterfeiting code has been sold, but not inspected, and the commodity is real;

the commodity associated with the anti-counterfeiting code is not sold, and the commodity is not real—not sold;

the commodity associated with the anti-counterfeiting code has been sold and has been inspected, and the commodity is real—but inspect repeatedly.

Specifically, the verification record data include number of the quality inspector, verification time whether the commodity is real, satellite positioning coordinates and sea level of the input device 10 at the verification time, and the verification result whether the commodity is real.

In one example of the present invention, confirm the commodity represented by the anti-counterfeiting code to be real (program 1.4), and the verification server 30 searched according to the received anti-counterfeiting code. The detailed process includes:

Step 1. The verification server 30 searches in the anti-counterfeiting database of the verification server 30 after receiving an inquiry of the anti-counterfeiting code, and confirms whether the commodity represented by the anti-counterfeiting code is real;

the anti-counterfeiting code does not have associated commodity: the commodity is not real—no such commodity;

the commodity associated with the anti-counterfeiting code has been sold, but not inspected: the commodity is real;

the commodity associated with the anti-counterfeiting code is not sold: the commodity is not real—not sold;

the commodity associated with the anti-counterfeiting code has been sold and has been inspected: the commodity is real—but inspect repeatedly.

Particularly, this step is for searching only, and will not update the anti-counterfeiting database within the verification server 30;

Step 2. The verification server 30 replies the input device 10 with the verification result;

Step 3. The input device 10 reads the verification result of the verification server 30, and displays on the display of the input device 10;

Step 4. The input device 10 record the verification record data within the input device 10, and the verification record data include:

the number of the verifier;

verification time, in one of the embodiments, the verification time is the system time of the input device 10 when the input device 10 reads the anti-counterfeiting code;

satellite positioning coordinates of the input device 10 at that time, including sea level;

the verification result.

In the twenty-first example of the present invention, the verification server 30 includes a second anti-counterfeiting database; the method further comprises:

updating, by the verification report server 20 and the verification server 30, verification information of the anti-counterfeiting code of the commodity synchronously in the second anti-counterfeiting database of the verification report server 20 and the first anti-counterfeiting database of the verification report server 20 after the anti-counterfeiting code of the commodity passes verification.

In the twenty-second example of the present invention, the method further comprises:

receiving, by the verification report server 20, an anti-counterfeiting code preparation inspection requirement of the commodity; judging whether the anti-counterfeiting code preparation inspection requirement of the commodity exists in the first anti-counterfeiting database, if existing, not adding the anti-counterfeiting code preparation inspection requirement in the first anti-counterfeiting database, and if not existing, adding the anti-counterfeiting code preparation inspection requirement in the first anti-counterfeiting database; and

receiving, by the verification server 30, the anti-counterfeiting code preparation inspection requirement of the commodity; judging whether the anti-counterfeiting code preparation inspection requirement of the commodity exists in the second anti-counterfeiting database, if existing, not adding the anti-counterfeiting code preparation inspection requirement in the second anti-counterfeiting database, and if not existing, adding the anti-counterfeiting code preparation inspection requirement in the second anti-counterfeiting database.

In the twenty-third example of the present invention, the method further comprises:

searching, by the verification server 30, corresponding anti-counterfeiting code record with the anti-counterfeiting code of the commodity in the first anti-counterfeiting database of the verification server 30, downloading the anti-counterfeiting code record searched in the first anti-counterfeiting database to the first storage module of the input device 10, and storing as data record before update of the anti-counterfeiting code;

updating, by the verification server 30, the anti-counterfeiting code of the commodity in the first anti-counterfeiting database of the verification server 30, and updating the record successfully when the searched anti-counterfeiting code record is consistent with the anti-counterfeiting data record after update stored in the input device 10.

In the twenty-fourth example of the present invention, the method further comprises:

searching, by the verification server 30, corresponding anti-counterfeiting code record with the anti-counterfeiting code of the commodity in the first anti-counterfeiting database of the verification server 30, downloading the anti-counterfeiting code record searched in the first anti-counterfeiting database to the input device 10, and storing as data record before update of the anti-counterfeiting code; and

updating, by the verification server 30, the anti-counterfeiting code of the commodity in the first anti-counterfeiting database of the verification server 30, and updating the record successfully when the searched anti-counterfeiting code record is consistent with the anti-counterfeiting data record after update stored in the input device 10.

In the twenty-fifth example of the present invention, the method further comprises:

searching, by the verification server 30, the anti-counterfeiting code record with the anti-counterfeiting code in the first anti-counterfeiting database; and

replying, by the verification server 30, updating successful or unsuccessful result to the input device 10 after comparing the searched result with the anti-counterfeiting data stored in the input device 10.

In the twenty-sixth example of the present invention, the input device 10 stores anti-counterfeiting data log record; the method further comprises:

establishing, by the verification server 30, an anti-counterfeiting data log database in the verification server 30;

searching, by the verification server 30, with the anti-counterfeiting code and the number of the quality inspector in the anti-counterfeiting data log database, and when the search result is one or more records, finding out whether the one or more records is consistent with the anti-counterfeiting data log record; and

deleting, by the verification server 30, the one or more records when the one or more records is consistent with the anti-counterfeiting data log record.

In the twenty-seventh example of the present invention, the method further comprises:

searching, by the verification report server 20, record of the anti-counterfeiting code preparation inspection requirement with the anti-counterfeiting code in the first anti-counterfeiting database after the first anti-counterfeiting database fails to add the anti-counterfeiting code preparation inspection requirement; and

deleting, by the verification report server 20, the record of the anti-counterfeiting code preparation inspection requirement in the first anti-counterfeiting database when the record of the anti-counterfeiting code preparation inspection requirement exists, and the number of the quality inspector in the record is the same as the number of the quality inspector who operates the input device 10.

In the twenty-eighth example of the present invention, the method further comprises:

searching, by the verification server 30, record of the anti-counterfeiting code preparation inspection requirement with the anti-counterfeiting code in the second anti-counterfeiting database after the second anti-counterfeiting database fails to add the anti-counterfeiting code preparation inspection requirement; and

deleting, by the verification server 30, the record of the anti-counterfeiting code preparation inspection requirement in the second anti-counterfeiting database when the record of the anti-counterfeiting code preparation inspection requirement exists, and the number of the quality inspector in the record is the same as the number of the quality inspector who operates the input device 10.

In one example of the present invention, commodity anti-counterfeiting update-self-coding two phase commit program (1.5.1)

In order to achieve synchronous update, a method of two phase commit is used in one of the embodiments, and some commercial database tools are provided with different basic programs to support synchronous update of database distributed with different servers. Here below is the way of configuring two phase commit in one of the embodiments, and the steps are as follows:

The First Phase: Commit Request Phase

Step 1. Add one record of the anti-counterfeiting code preparation inspection requirement in the verification server 30, and the anti-counterfeiting code preparation inspection requirement includes the following information:

the anti-counterfeiting code;

the number of the quality inspector;

a clock of the verification server 30;

As for searching the anti-counterfeiting code preparation inspection requirement respectively in the first and second anti-counterfeiting databases, the anti-counterfeiting code of the commodity is a unique search key, i.e., if the first and second anti-counterfeiting databases already have the same anti-counterfeiting code record, the record cannot be added, and under such circumstance, i.e., another program has added this record, i.e., another program is inspecting while not completing the entire update program. If the anti-counterfeiting code preparation inspection requirement has a certain anti-counterfeiting code record in the first and second anti-counterfeiting databases, it means that the anti-counterfeiting code is in the inspection process; and unsuccessful of adding the anti-counterfeiting code preparation inspection requirement is to prevent two inspectors from updating the record of the same anti-counterfeiting code synchronously.

Step 2. If adding the record of the anti-counterfeiting code preparation inspection requirement in step 1 is not successful, return to step 1. If repetition of step 1 exceeds a first predetermined times, jump to step 6. In one of the embodiments, the first predetermined times is five.

Step 3. Add one record of the anti-counterfeiting code preparation report requirement in the verification report server 20, the anti-counterfeiting code preparation report requirement includes the following information:

the anti-counterfeiting code;

the number of the quality inspector;

a clock of the verification report server 20;

The second receiving module 21 receives the anti-counterfeiting code preparation inspection requirement of the commodity transmitted by the input device 10, the second judgment module 24 judges whether an anti-counterfeiting code preparation report requirement of the commodity exists in the first anti-counterfeiting database, the anti-counterfeiting code preparation report requirement is in the first anti-counterfeiting database, and the anti-counterfeiting code of the commodity is an unique search key, i.e., if the first anti-counterfeiting database (which may also be called an anti-counterfeiting code preparation report requirement database) already has the same anti-counterfeiting code record, the record cannot be added, and under such circumstance, i.e., another program has added the record, i.e., another program is inspecting the report while not completing the entire update program. If the first anti-counterfeiting database has a certain anti-counterfeiting code record, it means that the anti-counterfeiting code is in the inspection process; unsuccessful of adding the anti-counterfeiting code preparation report requirement is to prevent two inspectors from updating the report record of the same anti-counterfeiting code synchronously. Similarly, the third receiving module 31 receives the anti-counterfeiting code preparation inspection requirement of the commodity; and the third judgment module 32 judges whether the anti-counterfeiting code preparation inspection requirement of the commodity exists in the second anti-counterfeiting database, i.e., if the second anti-counterfeiting database (which may also be called the anti-counterfeiting code preparation report requirement database) already has the same anti-counterfeiting code record, the record cannot be added.

Step 4. If adding the record of the anti-counterfeiting code preparation report requirement in step 2 is not successful, return to step 3. If repetition of step 3 exceeds a second predetermined times, jump to step 6. In one of the embodiments, the second predetermined times is five.

Step 5. The above steps 1-4 succeed in adding the record of the anti-counterfeiting code preparation inspection requirement in the verification server 30, and adding the record of the anti-counterfeiting code preparation report requirement in the verification report server 20, i.e., the two servers have prepared for the commit request phase. Enter the second phase, i.e., jump to step 10.

Step 6. At least one of the above steps 1-4 fails, i.e., the commit request of the first phase of program fails, clearly rollback the update program without leaving any trace. At this phase, the record of the anti-counterfeiting code preparation inspection requirement may be added in the verification server 30, or the record of the anti-counterfeiting code preparation report requirement may be added in the verification report server 20, so leave after clearing.

Step 7. Search, by the fourth searching module 26, with the anti-counterfeiting code in the anti-counterfeiting code preparation inspection requirement database, if existing that the number of the quality inspector who operates the input device 10 is consistent with the number of the quality inspector searched in the second anti-counterfeiting database, the second deleting module 302 removes the searched record from the anti-counterfeiting code preparation inspection requirement database.

Step 8. Search with the anti-counterfeiting code in the first anti-counterfeiting database of the verification report server 20, if existing that the number of the quality inspector who operates the input device 10 is consistent with the number of the quality inspector searched in the first anti-counterfeiting database, remove the searched record from the first anti-counterfeiting database.

Step 9. Transmit a wrong message to the input device 10, indicating that other inspector inspects the commodity with the same anti-counterfeiting code at the same time, which may be a system error, and requires the system personnel of the verification server 30 to investigate and correct; and may also be the same anti-counterfeiting code because the anti-counterfeiting code is stolen, and the first phase of program fails, rollback program 1.5.1 and do not enter into the second phase.

The Second Phase: Commit Phase

Enter into the second phase, i.e., the database may be updated.

Step 10. Search the single anti-counterfeiting code record with the anti-counterfeiting code in the second anti-counterfeiting database of the verification server 30, download the searched record of the whole database to the input device 10, store as an anti-counterfeiting data record before update, and prepare to update the data:

| | |
|---|---|
| data field name | anti-counterfeiting data record after update |
| the anti-counterfeiting | unchanged with the anti-counterfeiting data |
| code | record before update |
| sales time of the | unchanged with the anti-counterfeiting data |
| commodity | record before update |
| initial inspection time | if the original anti-counterfeiting data |
| of the commodity | record before update is null, update as a |
| | system clock of the verification server 30, |
| | otherwise, keep unchanged |
| inspection times of the | add one to the anti-counterfeiting data |
| commodity | record before update |

The anti-counterfeiting data record after update is stored in the input device 10, and an instruction is transmitted to the anti-counterfeiting database of the verification server 30 to update the record.

Step 11. Confirm successful of updating the record in step 10: in one of the embodiments, search the single anti-counterfeiting record with the anti-counterfeiting code in the second anti-counterfeiting database of the verification server 30, if the search result is consistent with the anti-counterfeiting data record after update stored in the input device 10, i.e., succeed in updating the record in step 10. In another embodiment, the instruction of updating the record transmitted to the verification server 30 in step 10 will get a response of successful or unsuccessful result. If the result of updating the record in step 10 is unsuccessful, go to step 20.

Step 12. Write the anti-counterfeiting data log: the establishing module 37 establishes the anti-counterfeiting data log database in the verification server 30 as table one below:

TABLE ONE

| | |
|---|---|
| data field name | anti-counterfeiting data log record |
| the anti-counterfeiting | unchanged with the anti-counterfeiting |
| code | data record before update |
| the number of the | data authenticated by the input device 10 |
| quality inspector | |
| verification result | verification result acquired in step 4, |
| | program 1.4 |
| verification time | verification time acquired in step 4, |
| | program 1.4 |

The anti-counterfeiting data log record is stored in the input device 10, and an instruction is transmitted to the anti-counterfeiting data log database of the verification server 30 to update the record.

Step 13. Confirm successful of updating the record in step 12: in one of the embodiments, search, by the third searching module 38, the record with the anti-counterfeiting code and the number of the quality inspector in the second anti-counterfeiting database (the anti-counterfeiting data log database) of the verification server 30, if the searched result is one or more records, finding out whether the searched record is consistent with the anti-counterfeiting data log record stored in the input device 10, i.e., succeed in updating the record in step 12. In another embodiment, the instruction of updating the record transmitted to the verification server 30 in step 12 will get a response of successful or unsuccessful result. If the result of updating the record in step 12 is unsuccessful, go to step 20.

Step 14. Write the anti-counterfeiting report data log record: firstly, acquire the commodity data represented by the anti-counterfeiting code, search with the commodity model of the anti-counterfeiting record acquired in step 10 of this program in the commodity database of the verification server 30, and acquire the commodity record, i.e., acquire the commodity producer and the commodity name in the commodity record.

The verification report log database established by the establishing module 37 in the verification server 30 includes table two below:

TABLE TWO

| | |
|---|---|
| data field name | verification report log record |
| the number of the | data authenticated by the input device 10 |
| quality inspector | |
| verification time | verification time acquired in step 4, |
| | program 1.4 (including second, minute, |
| | hour, date, month and year) |
| satellite positioning | satellite positioning coordinates |
| coordinates when | (including sea level) acquired in step 4, |
| verifying | program 1.4 |
| the anti-counterfeiting | unchanged with the anti-counterfeiting |
| code | data record before update |
| the commodity model | the commodity model acquired from the |
| | anti-counterfeiting data record |
| the commodity producer | the commodity producer acquired from |
| | the commodity record |
| the commodity name | the commodity name acquired from the |
| | commodity record |
| verification result | verification result acquired in step 4, |
| | program 1.4 |

The verification report log record is stored in the input device 10, and an instruction is transmitted to the verification report log database of the verification report server 20 to add the record.

Step 15. Confirm successful of adding the record in step 14: in one of the embodiments, search the record with the anti-counterfeiting code and the number of the quality inspector in the second anti-counterfeiting database of the verification server 30, if the searched result is one or more records, finding out whether the searched record is consistent with the verification report log record stored in the input device 10, i.e., succeed in updating the record in step 12. In another embodiment, the adding instruction transmitted to the verification server 30 in step 12 will get a response of successful or unsuccessful result. If the result of adding the record in step 14 is unsuccessful, go to step 20.

Step 16. Confirm all updates at the commit phase to be successfully, i.e., if the results in steps 11, 13 and 15 are confirmed all successful, unlock settings at the commit request phase of the first phase.

Step 17. Unlock the anti-counterfeiting code preparation inspection requirement of the verification server 30: search the second anti-counterfeiting database with the anti-counterfeiting code stored in the input device 10, read the single record, and delete, by the first deleting module 39, the searched record from the second anti-counterfeiting database.

Step 18. Unlock the anti-counterfeiting code preparation report requirement of the verification report server 20: search, by the fourth searching module 26, the first anti-counterfeiting database with the anti-counterfeiting code stored in the input device 10, read, by the second deleting module 27, the single record, and delete the searched record from the database.

Step 19. Complete this phase successfully.

Step 20. If one or more databases at this phase fails to update or add the record, clear the record.

Step 21. Search the single anti-counterfeiting record with the anti-counterfeiting code in the second anti-counterfeiting database of the verification server 30, and if the searched result is consistent with the anti-counterfeiting data record after update stored in the input device 10, i.e., succeed in updating the record in step 10, clear the update in step 10. Change the searched record in the second anti-counterfeiting database of the verification server 30 to the anti-counterfeiting data record before update stored in the input device 10, and transmit the update instruction to the second anti-counterfeiting database of the verification server 30.

Step 22. Search with the anti-counterfeiting code and the number of the quality inspector in the anti-counterfeiting data log record of the verification server 30, if the searched result is one or more records, find out whether the searched record is consistent with the anti-counterfeiting data log record stored in the input device 10, i.e., succeed in updating the record in step 12, make clearance, and transmit an instruction of deleting the anti-counterfeiting data log record of the verification server 30 to the verification server 30.

Step 23. Search with the anti-counterfeiting code and the number of the quality inspector in the verification report log record of the verification report server 20, if the searched report log record is consistent, i.e., succeed in adding the record in step 14, make clearance, and transmit an instruction of deleting the verification report log record of the verification report server 20 to the verification report server 20.

Step 24. Unlock the anti-counterfeiting code preparation inspection requirement of the verification server 30: carry out step 17.

Step 25. Unlock the anti-counterfeiting code preparation report requirement of the verification report server 20: carry out step 18.

Step 26. Complete this phase unsuccessfully.

Commodity anti-counterfeiting update-utilizing the database engine to simplify two phase commit program (1.5.2) for coding.

In another embodiment, the database engine provides two phase commit, the two phase commit may be directly controlled with a more advanced program language, and the steps are as follows:

Step 31. Begin transaction;

Step 32. Search with the anti-counterfeiting code in the first anti-counterfeiting database of the verification server 30, and require read-lock settings for the searched record, i.e., other program reads the searched record only, and no writable.

Step 33. Update the acquired record of the first anti-counterfeiting database of the verification server 30 searched with the anti-counterfeiting code (referring to program 1.5.1, step 10).

Step 34. Add the anti-counterfeiting data log record in the second anti-counterfeiting database of the verification server 30 (referring to program 1.5.1, step 12).

Step 35. Add the verification report log data in the first anti-counterfeiting database of the verification report server 20 (referring to program 1.5.1, step 14).

Step 36. If any step 33, 34 or 35 is false, rollback, i.e., automatically reply all updates of steps 32, 33 and 34; unlock the read-lock settings in step 32; result is false, transaction ends and completes.

Step 37. Unlock the read-lock settings in step 32; result is false, transaction ends and completes.

In one example of the present invention, the inspection goods program (program one): steps in details

According to above explanations, the complete one is:

Step 41. Turn on the input device 10;

Step 42. Activate the security data of the quality inspector (program 1.1, i.e., the method of protecting the security data of the quality inspector used according to different embodiments, execute program 1.1.1, 1.1.2 or 1.1.3);

Step 43. Connect the input device 10 to the verification report server 20, transmits requirement for logging in the verification report server 20, and sends request login information according to the security data of the quality inspector acquired in step 2;

Step 45. Receive, by the verification report server 20, the request login information from the input device 10, compare the database of the quality inspector of the verification report server 20, check that the number of the quality inspector of the unencrypted portion within the request login information actually exists in the database, and require authentication from the certificate authority (CA) of the public key infrastructure, the request authentication information including the encrypted portion of the request login information transmitted by the input device 10;

Step 46. In one preferable embodiment, the verification report server 20 is a certificate authority of the public key infrastructure, or a registration authority, and the verification report server 20 self-authenticates the request login information.

Step 47. According to step 45 or 46, decrypt the encrypted portion within the request login information with the public key acquired from the public key infrastructure, record other data of the request login information, store the public key of the quality inspector for the use of communication conversation;

Step 48. In one of the embodiments, further check the request login information of the quality inspector, and execute program 1.2 (test whether the request login information is abnormal);

Step 49. Carry out the inspection good program after logging in the verification report server 20 is completed.

Step 410. Due to different manufacturing ways of the anti-counterfeiting codes of different commodities, execute different programs 1.3.1, 1.3.2 or 1.3.3 in the anti-counterfeiting code reading program 1.3 to read the anti-counterfeiting codes, and transmit the anti-counterfeiting codes to the verification server 30;

Step 411. Execute program 1.4 to confirm the authenticity of the commodity represented by the anti-counterfeiting code; if the commodity represented by the anti-counterfeiting code is counterfeit, still continue recording the log of verifying the counterfeit;

Step 412. Execute program 1.5 to make the commodity anti-counterfeiting update. In different embodiments, execute program 1.5.1 to self-ensure synchronization of the database, and execute program 1.5.2 to ensure synchronous updating of the database utilizing function of the specific database engine or other program.

Step 413. Complete updating, and if next commodity needs to be verified, go to step 410, otherwise, complete.

In one example of the present invention, it needs to inspect the goods report after the commodity inspection is completed.

After the inspection is completed, the quality inspector may self-request the report from the verification report server 20. The creation of the report is searched in the verification report log database of the verification report server 20, includes record of the specific quality inspector with selected specific dates, and is listed in different arrangements and selecting ways. In one of the embodiments, the verification report includes report one. The purpose achieved by report one includes confirming the listed anti-counterfeiting codes to be verified with the input device 10 used by the quality inspector, and the satellite positioning coordinates and time recorded when inspection starts, which is to further prevent the quality inspector from recording real at another place as inspection at the site.

Further, in another embodiment, now report one may increase or reduce items in the report, including verification result, etc. On the other hand, it also may filter record with different selections, for example, in one of the embodiments, report one only lists abnormal inspection results, including no such commodity, not selling the commodity, repeatedly verifying the commodity, etc.

In one embodiment of the present invention, the anti-counterfeiting database (the first and second anti-counterfeiting databases) is used for storing data of the commodity. The contents of the database are updated by the producers and retailers, and include updating the sales time. This database stores more data, but it is irrelevant to the present invention. The Description of the prior patent may be referred. This database stores the commodity model of each anti-counterfeiting code. Other commodity database is used when making the report. The commodity model is used to search static data of other commodity. The anti-counterfeiting code preparation inspection requirement database (the first and second anti-counterfeiting databases) is used for updating the databases of the two servers synchronously, when there is one record, it represents that a certain anti-counterfeiting code is updating, and other program shall not update the same anti-counterfeiting code. After update is completed, the record is deleted. The anti-counterfeiting data log database (the first and second anti-counterfeiting databases) is used for recording all activities for searching the anti-counterfeiting code. The activity record includes verification time and result. In another embodiment, this database further includes satellite positioning coordinates when verifying, and may help the producers and retailers to know the final (inspection) site of the commodity.

In addition, the verification report log database is used for recording all verification activities. The activity record includes the number of the quality inspector, verification time and result, satellite positioning coordinates when verifying, and the static data of the commodity including the commodity model, the commodity name and the like. The anti-counterfeiting code preparation report requirement database is used for updating the databases of the two servers synchronously, when there is one record, it represents that a certain anti-counterfeiting code is updating, and other program shall not update the same anti-counterfeiting code. After update is completed, the record is deleted.

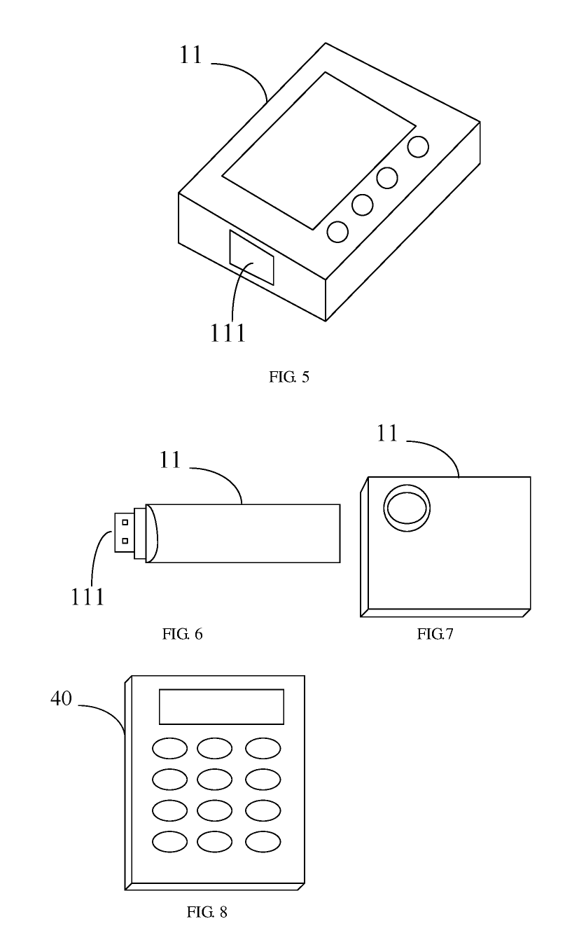

In one example of the present invention, FIG. 4 is a structure diagram of the input device 10 which includes a key board 110, a fingerprint scanner 120, and a lens scanner 130. Different embodiments have the input device 10 of different embodiments, and FIG. 5 is a device in the embodiment of the present invention, which installs the desired means on the same device. Preferably, the input device 10 is provided with a fingerprint scanning means which also includes all reading means of all anti-counterfeiting codes, and the reading means include the lens scanner 130, a near field channel read and write and Bluetooth communication device and the like.

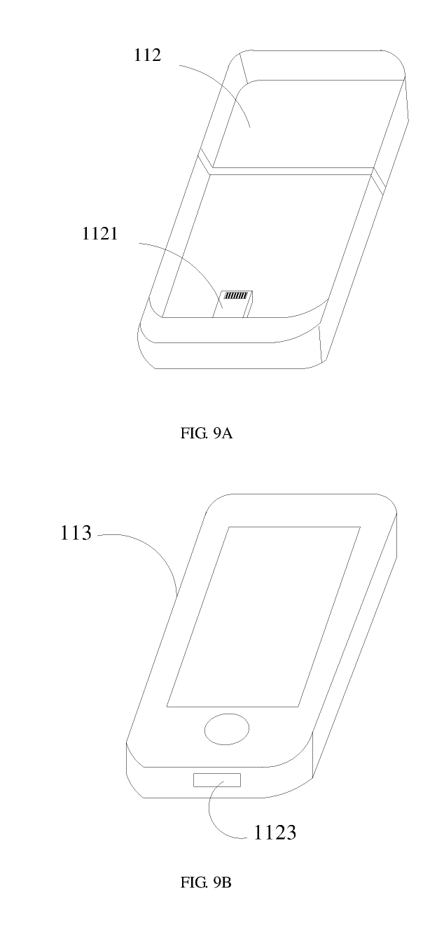

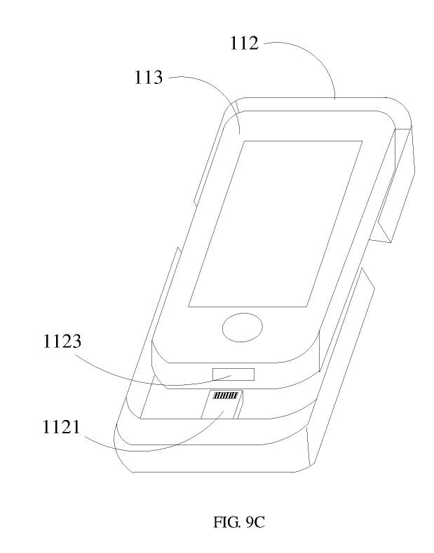

One embodiment of the present invention installs, such as, the encryption lock 11 of FIG. 5 or the encoder of FIG. 6, to the form as shown in FIGS. 9A-9C, wherein the assembled structure shown in FIG. 9C may form an input device 10. FIG. 9A shows adding a RFID chip 1121 on the mobile phone 113, i.e., the original mobile phone does not have the RFID chip. The shell 112 is provided with the RFID chip 1121 at the back of the phone. As shown in FIG. 9C, the RFID chip 1121 provided on the shell 112 is inserted into an interface 1123 on the mobile phone 113 to verify the associated data. Utilizing this concept, except adding the RFID chip 1121, the universal encryption lock 11 (as shown in FIG. 5) in the bank or the universal security encoder in the bank may be installed as the shell 112, and particularly, since adding the password has to be connected online via the mobile device, the device of the shell 112 may be connected to the mobile phone utilizing the USB port. In the prior art, there is no encryption lock 11 connected to the mobile phone with the shell of the phone, wherein the mobile phone 113 may be iPhone 4 or iPhone 5 and the like. Accordingly, it may realize adding the RFID type credit card which may use touch type credit card like VISA pay wave on the current mobile phone. As shown in FIGS. 9A-9C, it may enclose the RFID chip on the iPhone shell, and connect with a program control within the iPhone whether payment is open, i.e., the prior art is to input the password in the iPhone program, and if the password is correct, the RFID of the shell 112 runs to open payment with the credit card. However, the current mobile phone, such as, iPhone 5s or old iPhone does not have the RFID chip 1121, so it must be provided with an external shell 112. Moreover, in this configuration, these encryption locks 11 (i.e., including the RFID chip 1121) have to be connected online with the computer, and read electronic certificates within the encryption locks 11 in the windows operation system of the computer. These devices are external, and need the USB with different connectors to be connected online with the computer. These functions may be configured on the shell 112 as shown in FIG. 9A, and do not require additional buttons and the display for processing, so in function, the shell 112 of the mobile phone provided in the present invention does not necessary need to provide buttons and a display screen on the encryption lock 11. In addition, the input device 10 may use the mobile phones as the main part, and provide other means externally. The mobile phone is iPhone 5, and the shell of iPhone 5 includes the encryption lock 11 and a backup battery, such as, configure and supplement means that the original mobile phone does not have in a way of the shell of one mobile phone. Further, in another example, the input device 10 may be a mobile phone or a desktop computer with an external encryption lock 11 via different USB connection wires. The external encryption lock 11 includes a mini-USB receptacle used in FIGS. 5 and 6, or a USB-A plug in FIG. 7. The device including the encryption lock 11 as shown in FIGS. 6 and 7 has buttons and a display screen.

In another example, the security data of the quality inspector may be stored at a lock pin using an encrypted method, and connected to the input device 10 via Bluetooth or near field communication. For example, in FIG. 7, the encrypted data are stored, and small holes are provided as buttons to button up on the key chain or other personal belonging of the quality inspector. FIG. 8 is one of the security encoder 40, which is provided with input buttons and a display. The quality inspector activates the security encoder 40, inputs the password of the security encoder 40 which displays a single use token, and uses the token to carry out further logon program (program 1.1.2, steps 1-3) in the input device 10.

Report One
Verification report
Verification date: Sep. 1, 2015
Number of the quality inspector: Staff ID-001
Inspection address: HK/Hong Kong Island/Aberdeen subway site No. 1
Satellite positioning coordinates: latitude: 22.24688357/longitude: 114.15585235/sea level: 6 meters

| Anti-counterfeiting | Commod- | |
|---|---|---|
| code | ity model | Commodity name |
| 12345678901234567890 | RB02215 | Hyundai Rebar #22 15 meter long |
| 12345678901234567891 | RB02215 | Hyundai Rebar #22 15 meter long |
| 12345678901234567892 | RB02215 | Hyundai Rebar #22 15 meter long |
| 12345678901234567893 | RB02215 | Hyundai Rebar #22 15 meter long |
| 12345678901234567894 | RB02220 | Hyundai Rebar #22 20 meter long |
| 12345678901234567895 | RB02220 | Hyundai Rebar #22 20 meter long |
| 12345678901234567896 | RB02220 | Hyundai Rebar #22 20 meter long |
| 12345678901234567897 | RB02220 | Hyundai Rebar #22 20 meter long |
| 12345678901234567898 | RB02220 | Hyundai Rebar #22 20 meter long |
| 12345678901234567899 | RB02220 | Hyundai Rebar #22 20 meter long |
| 123456xx901234567890 | IET1x4X | Cross 1 × 4 two-layer aluminum |
| | | window |
| 123456xx901234567891 | IET1x4X | Cross 1 × 4 two-layer aluminum |
| | | window |
| 123456xx901234567892 | IET1x4X | Cross 1 × 4 two-layer aluminum |
| | | window |

Verification date: Sep. 4, 2015
Number of the quality inspector: Staff ID-001
Inspection address: HK/Hong Kong Island/Aberdeen subway site No. 1
Satellite positioning coordinates: latitude: 22.24688357/longitude: 114.15585235/sea level: 6 meters

| Anti-counterfeiting | Commod- | |
|---|---|---|
| code | ity model | Commodity name |
| 12341678901234567890 | RB02215 | Hyundai Rebar #22 15 meter long |
| 12341678901234567891 | RB02215 | Hyundai Rebar #22 15 meter long |
| 12341678901234567892 | RB02215 | Hyundai Rebar #22 15 meter long |
| 12341678901234567893 | RB02215 | Hyundai Rebar #22 15 meter long |
| 12341678901234567894 | RB02220 | Hyundai Rebar #22 20 meter long |
| 12341678901234567895 | RB02220 | Hyundai Rebar #22 20 meter long |
| 12341678901234567896 | RB02220 | Hyundai Rebar #22 20 meter long |
| 12341678901234567897 | RB02220 | Hyundai Rebar #22 20 meter long |
| 12341678901234567898 | RB02220 | Hyundai Rebar #22 20 meter long |
| 12341678901234567899 | RB02220 | Hyundai Rebar #22 20 meter long |
| 123416xx901234567890 | IET1x4X | Cross 1 × 4 two-layer aluminum |
| | | window |
| 123416xx901234567891 | IET1x4X | Cross 1 × 4 two-layer aluminum |
| | | window |
| 123416xx901234567892 | IET1x4X | Cross 1 × 4 two-layer aluminum |
| | | window |

In conclusion, the inspection device provided by the present invention comprises an input device communicatively connected to a verification report server and a verification server; the input device for activating security data of a quality inspector of the commodity, transmitting the security data to the verification report server for verification, reading an anti-counterfeiting code of the commodity after the security data pass verification, and transmitting the anti-counterfeiting code to the verification server; the verification report server receiving the security data and verifying the security data; and the verification server receiving the anti-counterfeiting code of the commodity to verify the anti-counterfeiting code. Thus, it realizes authentication of personnel who is responsible for inspecting the commodity, and prevents a qualified professional from notifying another unqualified personnel of the account and password to inspect the commodity. Since identification of identity of the quality inspector is enhanced on the input device, and then the employer or management collects the inspection report, it realizes enhancing authentication of identity of the quality inspector on the input device and verification of recording the inspection time and address and other data, and ensures legal quality inspectors to inspect the commodity.

Of course, the present invention may also have other several examples, and those skilled in the art may make various corresponding modifications and deformations according to the present invention without departing from the spirit and essence of the invention, but these corresponding modifications and deformations shall belong to the scope protected by the appended claims in the present invention.

1. An inspection device, comprising:
an input device communicatively connected to a verification report server and a verification server for activating security data of a quality inspector of a commodity, transmitting the security data to the verification report server for verification, reading an anti-counterfeiting code of the commodity after the security data pass verification, and transmitting the anti-counterfeiting code to the verification server;
wherein the verification report server receiving the security data and verifying the security data; and
wherein the verification server receiving the anti-counterfeiting code of the commodity to verify the anti-counterfeiting code.

2. The inspection device of claim 1, wherein the security data includes an unencrypted portion and an encrypted portion;
the unencrypted portion includes a number of the quality inspector;
the encrypted portion includes the number of the quality inspector, global positioning coordinates of the input device, logon time of the input device and a number of the input device, which are encrypted with a private key;
wherein after the input device activates the security data and transmits the security data to the verification report server, the verification report server decrypts the encrypted portion with a public key corresponding to the private key, and acquires the security data;
the input device comprises an encryption lock where the security data are stored; the encryption lock having a preset encrypted activation code and a preset decryption program;
the input device comprises:
a pre-installed module for pre-installing the encrypted activation code;
a first transmission module for transmitting the encrypted activation code pre-installed in the pre-installed module to the encryption lock when the input device activates the security data of the quality inspector of the commodity;
a first receiving module for transmitting the confidential data in an encryption way after the encryption lock receives and confirms the activation code of the encryption lock to be correct; and
a first decryption module for decrypting the security data with the preset decryption program and transmitting the security data to the verification report server;
the inspection device comprises:
at least one security encoder generating a token having a time limit for the quality inspector, the token being invalid when reaching the time limit; and
the input device comprises:
a first storage module for storing information of the token;
a first input module for inputting the token when the input device activates the security data of the quality inspector of the commodity;
a first judgment module for checking the token input from the first input module according to the information of the token stored in the first storage module;
an activation module for activating the security data of the quality inspector after the first judgment module judges the taken to be correct; and
a first transmission module for transmitting the activated security data of the quality inspector to the verification report server.

3. The inspection device of claim 2, wherein the security encoder has a preset security encoder activation password, and the security encoder is activated with the security encoder password;
wherein after the first judgment module checks the token input from the first input module to be correct, the activation module activates the security data of the quality inspector stored in the first storage module.

4. The inspection device of claim 2, wherein the first storage module stores a biological feature information base including biological feature information of the quality inspector, and the input device comprises:
a biological feature reading device for reading biological features of the quality inspector, and judging whether the biological features of the quality inspector are consistent with the biological features in the biological feature information base stored within the first storage module; and
wherein the activation module activates the security data when the biological feature reading device judges and reads the biological features of the quality inspector to be consistent with the biological features in the biological feature information base stored within the first storage module.

5. The inspection device of claim 4, wherein the biological feature reading device comprises at least one of a scanning fingerprint instrument or a scanning eyeball iris instrument.

6. The inspection device of claim 2, wherein the encryption lock is disposed on a shell of the input device, and the encryption lock is connected to the input device via a USB interface.

7. The inspection device of claim 1, wherein the verification report server comprises:
a second receiving module for receiving the activated security data of the quality inspector transmitted by the input device;
a second decryption module for decrypting the encrypted portion with a public key corresponding to the private key, and acquiring the security data;
a recording module for recording last logon time and address of the quality inspector; and
a second judgment module for judging whether movement of the quality inspector is reasonable according to the global positioning coordinates of the input device, if reasonable, allowing the quality inspector to login, and if unreasonable, not allowing the quality inspector to login.

8. The inspection device of claim 1, wherein the anti-counterfeiting code of the commodity is one of printed on the commodity, or sticks on the commodity in a form of sticker; the anti-counterfeiting code comprises optical readable characters, bar code and QR code;
the input device comprises:
a scanning lens or camera lens for scanning or reading the anti-counterfeiting code; and
a conversion module for converting the scanned anti-counterfeiting code into a digital anti-counterfeiting code; and
wherein the first transmission module transmits the converted anti-counterfeiting code to the verification server.

9. The inspection device of claim 1, wherein the anti-counterfeiting code is stored in one of a read only low frequency RFIDtag or stored in a rewritable high frequency RFIDtag;
the input device comprises:
a near field communication device for reading the anti-counterfeiting code stored in the low frequency RFIDtag, or reading the anti-counterfeiting code stored in the high frequency RFIDtag and verification status of the high frequency RFIDtag;
a conversion module for converting the scanned anti-counterfeiting code into a digital anti-counterfeiting code; and
wherein the first transmission module transmits the converted anti-counterfeiting code to the verification server.

10. The inspection device of claim 1, wherein the anti-counterfeiting code is stored in a rewritable iBeacon device; the iBeacon being one of stuck on the commodity to be damageable when removing, or removably installed on the commodity in a separate tag; an iBeacon power supply storing the anti-counterfeiting code charged with electricity to activate the iBeacon after damageable removing the barrier;
the input device comprises:
a Bluetooth read-write device for reading the anti-counterfeiting code stored in the iBeacon and updating the verification status of the iBeacon device;
a conversion module for converting the scanned anti-counterfeiting code into a digital anti-counterfeiting code; and
wherein the first transmission module transmits the converted anti-counterfeiting code to the verification server.

11. The inspection device of claim 1, wherein the verification server comprises a first anti-counterfeiting database;
wherein the verification server searches in the first anti-counterfeiting database after receiving the anti-counterfeiting code, verifies whether the commodity represented by the anti-counterfeiting code is real, and returns a verification result to the input device;
wherein the input device receives the verification result of the verification server, displays on a display of the input device, and records verification record data whether the commodity is real in the input device;
wherein the verification record data include number of the quality inspector, verification time whether the commodity is real, satellite positioning coordinates and sea level of the input device at the verification time, and the verification result whether the commodity is real; and
wherein the verification result whether the commodity is real comprises:
the commodity associated with the anti-counterfeiting code is not real—no such commodity;
the commodity associated with the anti-counterfeiting code has been sold, but not inspected, and the commodity is real;
the commodity associated with the anti-counterfeiting code is not sold, and the commodity is not real—not sold; and
the commodity associated with the anti-counterfeiting code has been sold and has been inspected, and the commodity is real—but inspect repeatedly.

12. The inspection device of claim 2, wherein the first input module of the input device comprises a keyboard and a display device, the quality inspector inputs the anti-counterfeiting code by the keyboard, and the keyboard includes a physical keyboard or a touch type keyboard which is formed of a part of positions of the display device.

13. The inspection device of claim 1, wherein the input device is one of wired or wireless communicatively connected to the verification server and the verification report server, respectively; and
the wireless communicatively connection comprises at least one of WIFI network connection, Bluetooth connection or mobile network connection.

14. The inspection device of claim 2, wherein the verification server comprises a second anti-counterfeiting database; the verification report server and the verification server used for updating verification information of the anti-counterfeiting code of the commodity synchronously in the second anti-counterfeiting database of the verification report server and the first anti-counterfeiting database of the verification report server, respectively, after the anti-counterfeiting code of the commodity passes verification;
the verification report server comprises:
a second receiving module for receiving an anti-counterfeiting code preparation inspection requirement of the commodity;
a second judgment module for judging whether the anti-counterfeiting code preparation inspection requirement of the commodity exists in the first anti-counterfeiting database, if existing, not adding the anti-counterfeiting code preparation inspection requirement in the first anti-counterfeiting database, and if not existing, adding the anti-counterfeiting code preparation inspection requirement in the first anti-counterfeiting database; and
the verification server comprises:
a third receiving module for receiving the anti-counterfeiting code preparation inspection requirement of the commodity;
a third judgment module for judging whether the anti-counterfeiting code preparation inspection requirement of the commodity exists in the second anti-counterfeiting database, if existing, not adding the anti-counterfeiting code preparation inspection requirement in the second anti-counterfeiting database, and if not existing, adding the anti-counterfeiting code preparation inspection requirement in the second anti-counterfeiting database.

15. The inspection device of claim 14, wherein the verification server comprises:
a first searching module for searching corresponding anti-counterfeiting code record with the anti-counterfeiting code of the commodity in the first anti-counterfeiting database of the verification server, downloading the anti-counterfeiting code record the searched in the first anti-counterfeiting database to the first storage module of the input device, and storing as data record before update of the anti-counterfeiting code; and
a first updating module for updating the anti-counterfeiting code of the commodity in the first anti-counterfeiting database of the verification server, and updating the record successfully when the searched anti-counterfeiting code record is consistent with the anti-counterfeiting data record after update stored in the input device.

16. The inspection device of claim 14, wherein the verification server comprises:
a second searching module for searching the anti-counterfeiting code record with the anti-counterfeiting code in the first anti-counterfeiting database; and
a first replying module for replying updating successful or unsuccessful result to the input device after comparing the searched result with the anti-counterfeiting data stored in the input device.

17. The inspection device of claim 14, wherein the first storage module of the input device stores anti-counterfeiting data log record;
the verification server comprises:
an establishing module for establishing an anti-counterfeiting data log database in the verification server;
a third searching module for searching with the anti-counterfeiting code and the number of the quality inspector in the anti-counterfeiting data log database, and when the search result is one or more records, finding out whether the one or more records is consistent with the anti-counterfeiting data log record; and
a first deleting module for deleting the one or lore records when the one or more records is consistent with the anti-counterfeiting data log record.

18. The inspection device of claim 14, wherein the verification report server comprises:
a fourth searching module for searching record of the anti-counterfeiting code preparation inspection requirement with the at code in the first anti-counterfeiting database after the first anti-counterfeiting database fails to add the anti-counterfeiting code preparation inspection, requirement; and
a second deleting module for deleting the record of the anti-counterfeiting code preparation inspection requirement in the first anti-counterfeiting database when the record of the anti-counterfeiting code preparation inspection requirement is searched by the fourth searching module, and the number of the quality inspector in the record is the same as the number of the quality inspector who operates the input device.

19. The inspection device of claim 14, wherein the verification server comprises:
a fourth searching module for searching record of the anti-counterfeiting code preparation inspection requirement with the anti-counterfeiting code in the second anti-counterfeiting database after the second anti-counterfeiting database fails to add the anti-counterfeiting code preparation inspection requirement; and
a second deleting module for deleting the record of the anti-counterfeiting code preparation inspection requirement in the second, anti-counterfeiting database when the record of the anti-counterfeiting code preparation inspection requirement is searched by the fourth searching module, and the number of the quality inspector in the record is the same as the number of the quality inspector who operates the input device.

20. An inspection method utilizing the inspection device of claim 1, wherein the method comprises:
A. activates security data of a quality inspector of the commodity by the input device, transmits the security data to the verification report server for verification, reads an anti-counterfeiting code of the commodity after the security data pass verification, and transmits the anti-counterfeiting code to the verification server;
B. receives the security data and verifies the security data by the verification report server; and
C. receives the anti-counterfeiting code of the commodity to verify the anti-counterfeiting code by the verification server.

21. The method of claim 20, wherein the security data includes an unencrypted portion and an encrypted portion;
the unencrypted portion includes number of the quality inspector;
the encrypted portion includes the number of the quality inspector, global positioning coordinates of the input device, logon time of the input device and number of the input device, which are encrypted using a private key;
after the input device activates the security data and transmits the security data to the verification report server, the verification report server decrypts the encrypted portion with a public key corresponding to the private key, and, acquires the security data;
the input device further includes an encryption lock where the security data are stored; the encryption lock having a preset encrypted activation code and a preset decryption program;
the step that the input device activates the security data of the quality inspector of commodity and transmits the security data to the verification report server for verification comprises:
pre-installing, by the input device, the encrypted activation code;
transmitting the pre-installed encrypted activation code to the encryption lock when the input device activates the security data of the quality inspector of the commodity;
transmitting the confidential data to the input device in an encryption way after the encryption lock receives and confirms the activation code of the encryption lock to be correct, decrypting, by the input device, the security data with the preset decryption program and transmitting the security data to the verification report server for verification;
the inspection device further comprises:
at least one security encoder generating a token having a time limit for the quality inspector, the token being invalid when reaching the time limit;
the step that the input device activates the security data of the quality inspector of commodity and transmits the security data to the verification report server for verification further comprises:
storing, by the input device, information of the token;
inputting the token when the input device activates the security data of the quality inspector of the commodity;
checking, by the input device, the input token according to the information of the token, activating, by the input device, the security data of the quality inspector after judging the token to be correct; and transmitting the activated security data of the quality inspector to the verification report server.

22. The method of claim 21, wherein the security encoder has a preset security encoder activation password, and the security encoder is activated with the security encoder password;
activating the stored security data of the quality inspector after the input device checks the input token to be correct.

23. The method of claim 21, wherein the input device stores a biological feature information base including biological feature information of the quality inspector; the input device further includes a biological feature reading device;
the step that the input device activates the security data of the quality inspector of the commodity and transmits the security data to the verification report server for verification further comprises:
reading, by the biological feature reading device, biological features of the quality inspector, and judging whether the biological features of the quality inspector are consistent with the biological features in the biological feature information base; and
activating, by the input device, the security data when the biological feature reading device judges and reads the biological features of the quality inspector to be consistent with the biological features in the biological feature information base.

24. The method of claim 23, wherein the biological feature reading device comprises at least one of a scanning fingerprint instrument or a scanning eyeball iris instrument.

25. The method of claim 21, wherein the encryption lock is disposed on a shell of the input device, and the encryption lock is connected to the input device via a USB interface.

26. The method of claim 20, wherein step B comprises:
receiving, by the verification report server, the activated security data of the quality inspector transmitted by the input device;
decrypting, by the verification report server, the encrypted portion with a public key corresponding to the private key, and acquiring the security data;
recording, by the verification report server, last logon time and address of the quality inspector; and
judging, by the verification report server, whether movement of the quality inspector is reasonable according to the global positioning coordinates of the input device, if reasonable, allowing the quality inspector to login, and if unreasonable, not allowing the quality inspector to login.

27. The method of claim 20, wherein the anti-counterfeiting code of the commodity is one of printed on the commodity, or sticks on the commodity in a form of sticker; the anti-counterfeiting code comprising optical readable characters, bar code and QR code;
the input device comprising a scanning lens or camera lens; the step of reading the anti-counterfeiting code of the commodity after the security data pass verification, and transmitting the anti-counterfeiting code to the verification server comprises:
scanning or reading, by the scanning lens or camera lens of the input device, the anti-counterfeiting code of the commodity;
converting, by the input device, the scanned anti-counterfeiting code into a digital anti-counterfeiting code; and
transmitting, by the input device, the converted anti-counterfeiting code to the verification server.

28. The method of claim 20, wherein the anti-counterfeiting code is at least one of stored in a read only low frequency RFIDtag or stored in a rewritable high frequency RFIDtag;
the input device comprises a near field communication device; the step of reading the anti-counterfeiting code of the commodity after the security data pass verification, and transmitting the anti-counterfeiting code to the verification server comprises:
reading, by the near field communication device of the input device, the anti-counterfeiting code stored in the low frequency RFIDtag, or the anti-counterfeiting rode stored in the high frequency RFIDtag and verification status of the high frequency RFIDtag on the commodity;
converting, by the input device, the scanned anti-counterfeiting code into a digital anti-counterfeiting code; and
transmitting, by the input device, the converted anti-counterfeiting code to the verification server.

29. The method of claim 20, wherein the anti-counterfeiting code is stored in a rewritable iBeacon device; the iBeacon being at least one of stuck on the commodity to be damageable when removing, or removably installed on the commodity in a separate tag; an iBeacon power supply storing the anti-counterfeiting code charged with electricity to activate the iBeacon after damageable removing the barrier;
the input device comprising a Bluetooth read-write device; the step of reading the anti-counterfeiting code of the commodity after the security data pass verification, and transmitting the anti-counterfeiting code to the verification server comprises:
reading, by the Bluetooth read-write device of the input device, the anti-counterfeiting code stored in the iBeacon and updating verification stags of the iBeacon device;
converting, by the input device, the scanned anti-counterfeiting code into a digital anti-counterfeiting code; and
transmitting, by the input device, the converted anti-counterfeiting code to the verification server.

30. The method of claim 20, wherein the verification server includes a first anti-counterfeiting database; wherein the step C comprises:
searching in the first anti-counterfeiting database after the verification serves receives the anti-counterfeiting code, verifying whether the commodity represented by the anti-counterfeiting code is real, and returning a verification result to the input device;
the method comprises:
receiving, by the input device, the verification result of the verification server, displaying on a display of the input device, and recording verification record data whether the commodity is real in the input device;
the verification record data include number of the quality inspector, verification time whether the commodity is real, satellite positioning coordinates and sea level of the input device at the verification time, and the verification result whether the commodity is real; and
the verification result whether the commodity is real includes:
the commodity associated with the anti-counterfeiting code is not real—no such commodity;
the commodity associated with the anti-counterfeiting code has been sold, but not inspected, and the commodity is real;
the commodity associated with the anti-counterfeiting code is not sold, and the commodity is not real—not sold;
the commodity associated with the anti-counterfeiting code has been sold and has been inspected, and the commodity is real—but inspect repeatedly.

31. The method of claim 21, characterized in that the input device includes a keyboard and a display device, the quality inspector inputs the anti-counterfeiting code by the keyboard; and
the keyboard includes a physical keyboard or a touch-type keyboard which is formed of a part of positions of the display device.

32. The method of claim 20, wherein the input device is communicatively connected to the verification report server and the verification server, respectively; the input device being one of wired or wireless communicatively connected to the verification server and the verification report server, respectively; and
the wireless communicatively connection includes WIFI network connection, Bluetooth connection or mobile network connection.

33. The method of claim 21, wherein the verification server includes a second anti-counterfeiting database; the method comprises:
updating, by the verification report server and the verification server, verification information of the anti-counterfeiting code of the commodity synchronously in the second anti-counterfeiting database of the verification report server and the first anti-counterfeiting database of the verification report server, respectively, after the anti-counterfeiting code of the commodity passes verification;
receiving, by the verification report server, an anti-counterfeiting code preparation inspection requirement of the commodity; judging whether the anti-counterfeiting code preparation inspection requirement of the commodity exists in the first anti-counterfeiting database, if existing, not adding the anti-counterfeiting code preparation inspection requirement in the first anti-counterfeiting database, and if not existing, adding the anti-counterfeiting code preparation inspection requirement in the first anti-counterfeiting database; and
receiving, by the verification server, the anti-counterfeiting code preparation inspection requirement of the commodity; judging whether the anti-counterfeiting code preparation inspection requirement of the commodity exists in the second anti-counterfeiting database, if existing, not adding the anti-counterfeiting code preparation inspection requirement in the second anti-counterfeiting database, and if not existing, adding the anti-counterfeiting code preparation inspection requirement in the second anti-counterfeiting database.

34. The method of claim 33, wherein the method comprises:
searching, by the verification server, corresponding anti-counterfeiting code record with the anti-counterfeiting code of the commodity in the first anti-counterfeiting database of the verification server, downloading the anti-counterfeiting code record searched in the first anti-counterfeiting database to the first storage module of the input device, and storing as data record before update of the anti-counterfeiting code;
updating, by the verification server, the anti-counterfeiting code of the commodity in the first anti-counterfeiting database of the verification server, and updating the record successfully when the searched anti-counterfeiting code record is consistent with the anti-counterfeiting data record after update stored in the input device.

35. The method of claim 33, wherein the method comprises:
searching, by the verification server, corresponding anti-counterfeiting code record with the anti-counterfeiting code of the commodity in the first anti-counterfeiting database of the verification server, downloading the anti-counterfeiting code record searched in the first anti-counterfeiting database to the input device, and storing as data record before update of the anti-counterfeiting code;
updating, by the verification server, the anti-counterfeiting code of the commodity in the first anti-counterfeiting database of the verification server, and updating the record successfully when the searched anti-counterfeiting code record is consistent with the anti-counterfeiting data record after update stored in the input device.

36. The method of claim 33, wherein the method further comprises:
searching, by the verification server, the anti-counterfeiting code record with the anti-counterfeiting code in the first anti-counterfeiting database; and
replying, by the verification server, updating successful or unsuccessful result to the input device after comparing the searched result with the anti-counterfeiting data stored in the input device.

37. The method of claim 33, wherein the input device stores anti-counterfeiting data log record;
the method comprises:
establishing, by the verification server, an anti-counterfeiting data log database in the verification server;
searching, by the verification server, with the anti-counterfeiting code and the number of the quality inspector in the anti-counterfeiting data log database, and when the search result is one or more records, finding out whether the one or more records is consistent with the anti-counterfeiting data log record; and
deleting, by the verification server, the one or more records when the one or more records is consistent with the anti-counterfeiting data log record.

38. The method of claim 33, wherein the method comprises:
searching, by the verification report server, record of the anti-counterfeiting code preparation inspection requirement with the anti-counterfeiting code in the first anti-counterfeiting database after the first anti-counterfeiting database fails to add the anti-counterfeiting code preparation inspection requirement; and
deleting, by the verification report server, the record of the anti-counterfeiting code preparation inspection requirement in the first anti-counterfeiting database when the record of the anti-counterfeiting code preparation inspection requirement exists, and the number of the quality inspector in the record is the same as the number of the quality inspector who operates the input device.

39. The method of claim 33, wherein the method comprises:
searching, by the verification server, record of the anti-counterfeiting code preparation inspection requirement with the anti-counterfeiting code in the second anti-counterfeiting database after the second anti-counterfeiting database fails to add the anti-counterfeiting code preparation inspection requirement; and
deleting, by the verification server, the record of the anti-counterfeiting code preparation inspection requirement in the second anti-counterfeiting database when the record of the anti-counterfeiting code preparation inspection requirement exists, and the number of the quality inspector in the record is the same as the number of the quality inspector who operates the input device.
